(19) United States
(12) Patent Application Publication
(10) Pub. No.: US 2024/0348399 A1
(43) Pub. Date: Oct. 17, 2024

(54) SOUNDING REFERENCE SIGNAL RESOURCE INDICATOR WITH SOUNDING REFERENCE SIGNALS OF DIFFERENT DUPLEXING TYPES

(71) Applicant: QUALCOMM Incorporated, San Diego, CA (US)

(72) Inventors: Muhammad Sayed Khairy ABDELGHAFFAR, San Jose, CA (US); Abdelrahman Mohamed Ahmed Mohamed IBRAHIM, San Diego, CA (US); Mostafa KHOSHNEVISAN, San Diego, CA (US); Gokul SRIDHARAN, Sunnyvale, CA (US)

(21) Appl. No.: 18/620,271

(22) Filed: Mar. 28, 2024

Related U.S. Application Data
(60) Provisional application No. 63/496,646, filed on Apr. 17, 2023.

(51) Int. Cl. H04L 5/00; H04L 5/14

(52) U.S. Cl. CPC H04L 5/0051; H04L 5/14

(57) ABSTRACT

Various aspects relate generally to sounding reference signal (SRS) reference indicators (SRIs) indicating an SRS associated with a transmission configuration to use for transmission of a data channel communication. Some aspects more specifically relate to an SRI indicating an SRS from an SRS resource having a same duplexing type as a slot in which the data channel communication is scheduled. In some aspects, the SRI may indicate an SRS from an SRS resource that is not a most-recent SRS resource based on the most-recent SRS resource having a different duplexing type than the slot in which the data channel communication is scheduled.

### CROSS-REFERENCE TO RELATED APPLICATION

This Patent application claims priority to U.S. Provisional Patent Application No. 63/496,646, filed on Apr. 17, 2023, entitled “SOUNDING REFERENCE SIGNAL RESOURCE INDICATOR WITH SOUNDING REFERENCE SIGNALS OF DIFFERENT DUPLEXING TYPES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically, to techniques and apparatuses for sounding reference signal resource indicators with sounding reference signals of different duplexing types.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different user equipment (UEs) to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

A wireless communication may utilize beamforming to improve gain of the wireless communication. Beamforming may involve spatial manipulation of a transmission or reception of a wireless communication. Given that devices of a wireless communication network may move or change orientation, and that conditions (such as blockages, clusters, or the like) in a wireless communication network may change, networks implementing beamforming may use beam management or refinement processes to identify a suitable direction or shape for a beam, and then to refine or update the beam over the course of time. In some networks, a user equipment (UE) may transmit a sounding reference signal (SRS), which a network node (such as a gNB) may use to identify or update a suitable beam.

In some networks using beamforming for wireless communications, an SRS resource indicator (SRI) may indicate a configuration for a user equipment (UE) to use for a transmission. For example, the UE may transmit a set of SRSs to a network node, with each SRS of the set being transmitted with different parameters such as a spatial domain filter or uplink transmission configuration indicator (TCI). The network node may transmit an SRI to the UE to indicate which of the SRSs of the set of SRSs the UE is to use for selecting a configuration for an uplink transmission. The SRI may be associated with a most-recent transmission of SRSs (for example, within an SRS resource allocated for transmission of the set of SRSs).

In some networks that support subband full duplexing (also referred to as full duplexing), a UE may communicate with a network node via a set of slots that include uplink slots, downlink slots, and full duplexing slots. When communicating via the uplink slots, the UE may transmit on a full frequency band allocated to the UE. When communicating via the downlink slots, the UE may receive on a full frequency band allocated to the UE. When communicating via the full duplexing slots, the UE may transmit on a first portion of the full frequency band and may receive on a second portion of the full frequency band.

In some networks using beam forming and supporting subband full duplexing, the UE may transmit first SRSs within a first slot having a first duplexing configuration (for example, full duplexing or non-full duplexing, such as an uplink slot). The UE may transmit second SRSs within a second slot having a second duplexing configuration that is different from the first duplexing configuration. An SRI may be used to indicate a configuration for the UE to use for transmission of a data channel communication in a third slot having either the first duplexing configuration or the second duplexing configuration.

### SUMMARY

Some aspects described herein relate to a method of wireless communication performed by a user equipment (UE). The method may include transmitting a first sounding reference signal (SRS) associated with a first duplexing type and a second SRS associated with a second duplexing type that is different from the first duplexing type. The method may include receiving an indication to transmit a data channel communication, the indication including an SRS resource index (SRI) associated with one or more parameters for transmission of the data channel communication. The method may include transmitting the data channel communication in a slot having the first duplexing type and using a configuration indicated via the SRI and associated with a most-recent SRS associated with the first duplexing type.

Some aspects described herein relate to a method of wireless communication performed by a network node. The method may include receiving a first SRS associated with a first duplexing type and a second SRS associated with a second duplexing type that is different from the first duplexing type. The method may include transmitting an indication to transmit a data channel communication, the indication including an SRI associated with one or more parameters for transmission of the data channel communication. The method may include receiving the data channel communication in a slot having the first duplexing type and using a configuration indicated via the SRI and associated with a most-recent SRS associated with the first duplexing type.

Some aspects described herein relate to a UE for wireless communication. The user equipment may include at least one memory and at least one processor coupled with the at least one memory. The at least one processor may be operable to cause the user equipment to transmit a first SRS associated with a first duplexing type and a second SRS associated with a second duplexing type that is different from the first duplexing type. The at least one processor may be operable to cause the user equipment to receive an indication to transmit a data channel communication, the indication including an SRI associated with one or more parameters for transmission of the data channel communication. The at least one processor may be operable to cause the user equipment to transmit the data channel communication in a slot having the first duplexing type and using a configuration indicated via the SRI and associated with a most-recent SRS associated with the first duplexing type.

Some aspects described herein relate to a network node for wireless communication. The network node may include at least one memory and at least one processor coupled with the at least one memory. The at least one processor may be operable to cause the network node to receive a first SRS associated with a first duplexing type and a second SRS associated with a second duplexing type that is different from the first duplexing type. The at least one processor may be operable to cause the network node to transmit an indication to transmit a data channel communication, the indication including an SRI associated with one or more parameters for transmission of the data channel communication. The at least one processor may be operable to cause the network node to receive the data channel communication in a slot having the first duplexing type and using a configuration indicated via the SRI and associated with a most-recent SRS associated with the first duplexing type.

Some aspects described herein relate to a non-transitory computer-readable medium that stores a set of instructions for wireless communication by a UE. The set of instructions, when executed by one or more processors of the UE, may cause the UE to transmit a first SRS associated with a first duplexing type and a second SRS associated with a second duplexing type that is different from the first duplexing type. The set of instructions, when executed by one or more processors of the UE, may cause the UE to receive an indication to transmit a data channel communication, the indication including an SRI associated with one or more parameters for transmission of the data channel communication. The set of instructions, when executed by one or more processors of the UE, may cause the UE to transmit the data channel communication in a slot having the first duplexing type and using a configuration indicated via the SRI and associated with a most-recent SRS associated with the first duplexing type.

Some aspects described herein relate to a non-transitory computer-readable medium that stores a set of instructions for wireless communication by a network node. The set of instructions, when executed by one or more processors of the network node, may cause the network node to receive a first SRS associated with a first duplexing type and a second SRS associated with a second duplexing type that is different from the first duplexing type. The set of instructions, when executed by one or more processors of the network node, may cause the network node to transmit an indication to transmit a data channel communication, the indication including an SRI associated with one or more parameters for transmission of the data channel communication. The set of instructions, when executed by one or more processors of the network node, may cause the network node to receive the data channel communication in a slot having the first duplexing type and using a configuration indicated via the SRI and associated with a most-recent SRS associated with the first duplexing type.

Some aspects described herein relate to an apparatus for wireless communication. The apparatus may include means for transmitting a first SRS associated with a first duplexing type and a second SRS associated with a second duplexing type that is different from the first duplexing type. The apparatus may include means for receiving an indication to transmit a data channel communication, the indication including an SRI associated with one or more parameters for transmission of the data channel communication. The apparatus may include means for transmitting the data channel communication in a slot having the first duplexing type and using a configuration indicated via the SRI and associated with a most-recent SRS associated with the first duplexing type.

Some aspects described herein relate to an apparatus for wireless communication. The apparatus may include means for receiving a first SRS associated with a first duplexing type and a second SRS associated with a second duplexing type that is different from the first duplexing type. The apparatus may include means for transmitting an indication to transmit a data channel communication, the indication including an SRI associated with one or more parameters for transmission of the data channel communication. The apparatus may include means for receiving the data channel communication in a slot having the first duplexing type and using a configuration indicated via the SRI and associated with a most-recent SRS associated with the first duplexing type.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example network node in communication with a user equipment (UE) in a wireless network.

FIG. 3 is a diagram of an example associated with sounding reference signals (SRSs) in a network that supports subband full duplexing.

FIG. 4 is a diagram of an example associated with SRSs in a network that supports subband full duplexing.

FIG. 5 is a diagram of an example associated with SRS resource indicators (SRIs) with SRSs of different duplexing types.

FIG. 6 is a diagram of an example associated with SRSs having different duplexing types in a network that supports subband full duplex (SBFD).

FIG. 7 is a diagram of an example associated with SRSs having different duplexing types in a network that supports SBFD in context of non-codebook SRSs.

FIG. 8 is a diagram of an example associated with SRSs having different duplexing types in a network that supports SBFD in context of non-codebook SRSs.

FIG. 9 is a flowchart illustrating an example process performed, for example, by a UE that supports SRIs that can indicate SRSs based on duplexing types.

FIG. 10 is a flowchart illustrating an example process performed, for example, by a network node that supports SRIs that can indicate SRSs based on duplexing types.

FIG. 11 is a diagram of an example apparatus for wireless communication that supports SRIs that can indicate SRSs based on duplexing types.

FIG. 12 is a diagram of an example apparatus for wireless communication that supports SRIs that can indicate SRSs based on duplexing types.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A wireless communication may utilize beamforming to improve gain of the wireless communication. Beamforming may involve spatial manipulation of a transmission or reception of a wireless communication. Given that devices of a wireless communication network may move or change orientation, and that conditions (such as blockages, clusters, or the like) in a wireless communication network may change, networks implementing beamforming may use beam management or refinement processes to identify a suitable direction or shape for a beam, and then to refine or update the beam over the course of time. In some networks, a user equipment (UE) may transmit a sounding reference signal (SRS), which a network node (such as a gNB) may use to identify or update a suitable beam.

SRS transmission may be configured such that the UE and the network node have a common understanding of parameters of the SRS. For example, an SRS resource indicator (SRI) may indicate a configuration for a UE to use for a transmission. The UE may transmit a set of SRSs, with each SRS of the set being transmitted with different parameters such as a spatial domain filter or uplink transmission configuration indicator (TCI). The network node may transmit an SRI via a physical downlink control channel (PDCCH) to indicate which of the SRSs of the set of SRSs the UE is to use for selecting a configuration for an uplink transmission. The SRI may be associated with a most-recent transmission of SRSs (for example, within an SRS resource allocated for transmission of the set of SRSs).

A UE may transmit an uplink communication (for example, a physical uplink shared channel (PUSCH) communication) that is a codebook (CB) based communication or a non-CB-based communication. For a CB-based communication, the UE can be configured with only one SRS resource set with a “usage” parameter set to “codebook,” and the UE may have a maximum quantity of (for example, 4) SRS resources within the SRS resource set that can be configured. Each SRS resource may be radio resource control (RRC) configured with a number of ports (for example, nrofSRS-Ports). An SRI field in a downlink control information (DCI) message (scheduling a PUSCH communication) may indicate one SRS resource. A number of ports configured for the indicated SRS resource is associated with, or indicates, a number of antenna ports for the PUSCH communication. The UE transmits the PUSCH communication using a same spatial domain filter (for example, uplink beam) as the indicated SRS resource. A number of layers (rank) and transmission precoding matrix index (TPMI) for the PUSCH communication is determined from a separate DCI field, such as a “precoding information and number of layers” field.

For non-CB-based transmissions, the UE may be configured with only one SRS resource set with a “usage” parameter set to “noncodebook.” The UE may have a maximum quantity (for example, 4) SRS resources within the SRS resource set that can be configured. Each SRS resource may be associated with one port for transmission. An SRI field in a DCI message that schedules a PUSCH communication may indicate one or more SRS resources. A quantity of indicated SRS resources indicates a rank (for example, a number of layers) for the scheduled PUSCH communication. The UE transmits the PUSCH communication with a same spatial domain filter (for example, uplink beam) as the indicated SRS resource.

In both CB-based transmissions and non-CB-based transmissions, a size of an SRI field is a function of a number of SRS resources within the SRS resource set. The indicated SRI in slot n is associated with the most recent transmission of one or more SRS resources identified by the SRI, where the SRS transmission is prior to a PDCCH carrying the SRI.

Sub-band full duplex (SBFD) communication may involve dividing a communication bandwidth, such as a carrier or a cell, into one or more uplink sub-bands and one or more downlink sub-bands that occur at the same time. SBFD can be implemented in a time division duplexing (TDD) carrier, in which some slots or symbols are treated as uplink slots or symbols (and thus include only uplink resources), some slots or symbols are treated as downlink slots or symbols (and thus include only downlink resources), and some slots or symbols are treated as SBFD slots or symbols (and thus include uplink resources in an uplink sub-band and downlink resources in a downlink sub-band). SBFD can be applied at the UE, the network node, or both. SBFD operation may increase network capacity relative to half-duplex operation.

However, when selecting an SRS in a network that supports SBFD symbols and non-SBFD symbols, selection of an SRS (using an SRI) from a most-recent SRS may reduce transmission efficiency or increase an error rate of uplink communication. For example, this may be associated with a difference in uplink link quality in SBFD symbols as compared non-SBFD symbols. In SBFD symbols, there may be residual self-interference (SI) in addition to cross-link interference (CLI) from another network node. To avoid or reduce interference, the network node may use a different reception combiner or different reception beam, as some directions may be jammed by the SI or the CLI. Also, the network node may have different antenna or panel configurations in SBFD symbols and non-SBFD symbols. Additionally or alternatively, an uplink communication may use a different set of frequency resources when using SBFD versus non-SBFD, or the UE may have different transmission power or per-resource (for example, per resource block) transmission power.

Various aspects relate generally to SRIs indicating an SRS associated with a transmission configuration to use for transmission of an uplink data channel communication.

Some aspects more specifically relate to an SRI indicating one or more SRS resources having a same duplexing type as a slot in which the data channel communication is scheduled or configured. In some aspects, the SRI may indicate an SRS from an SRS resource that is not a most-recent SRS resource based on the most-recent SRS resource having a different duplexing type than the slot in which the data channel communication is scheduled. For example, when two SRS resource sets with the same usage parameter are configured (one SRS set per duplexing type), the SRI may indicate an SRS that is a most-recent SRS resource of an SRS resource set having the same duplexing type as the slot in which the data channel communication is scheduled. In some aspects, the two SRS resource sets with the same usage parameter may be configured for a given transmission reception point (TRP) or panel. Additionally, or alternatively, if an SRS resource set includes SBFD-specific SRS resources and non-SBFD-specific SRS resources, the SRI may indicate an SRS that is the most-recent SRS resource having the same duplexing type as the slot in which the data channel communication is scheduled.

In some aspects, a single SRS set may be configured with a non-codebook usage parameter, and SRS transmission in SBFD symbols may be associated with a subset of CSI-RS ports of a CSI-RS resource associated with the single SRS set. For example, SRS transmission in SBFD symbols may be associated with a subset of CSI-RS ports of the CSI-RS resource, and SRS transmission in non-SBFD symbols may be associated with all CSI-RS ports of the CSI-RS resource. Alternatively, a single SRS set may be configured with a non-codebook usage parameter and associated with two CSI-RS resources: one CSI-RS resource for SRS transmission in SBFD symbols and another CSI-RS resource for SRS transmission in non-SBFD symbols. Additionally, or alternatively, in some aspects, two SRS sets are configured with a non-codebook usage parameter, and each SRS set is associated with a respective CSI-RS.

Particular aspects of the subject matter described in this disclosure can be implemented to realize one or more of the following potential advantages. In some examples, the described techniques can be used to improve transmission configurations in networks that support full duplexing. For example, by using the SRI to indicate an SRS from an SRS resource having a same duplexing type as a data channel communication, the SRI may indicate best transmission parameters associated with the duplexing type. By indicating the best transmission parameters associated with a duplexing type, the UE may be indicated to use the best transmission beam (for example, associated with a spatial domain filter) for an SBFD data channel communication or for a non-SBFD data channel communication.

By configuring two SRS sets with the same usage parameter (one SRS set per duplexing type), and indicate an SRS that is a most-recent SRS resource of an SRS set having the same duplexing type as the slot in which the data channel communication is scheduled, compatibility with legacy SRS set configurations is improved. By configuring the two SRS resource sets with the same usage parameter for a given transmission reception point (TRP) or panel, support for non-co-located TRPs is improved. By configuring an SRS set that includes SBFD-specific SRS resources and non-SBFD-specific SRS resources, and indicate an SRS that is the most-recent SRS resource having the same duplexing type as the slot in which the data channel communication is scheduled, efficiency of configuration of SRS sets is improved.

By configuring a single SRS set with a non-codebook usage parameter, and by associating SRS transmission in SBFD symbols with a subset of CSI-RS ports of a CSI-RS resource associated with the single SRS set, simplicity of CSI-RS resource configuration is improved. By configuring a single SRS set with a non-codebook usage parameter and an association with two CSI-RS resources, compatibility with legacy CSI-RS resource configuration is improved.

In this way, the network node may receive the data channel communication with improved signal-to-noise ratio (SNR) or signal-to-interference-plus-noise ratio (SINR), and may improve an error rate of uplink communications from the UE, which may conserve computing, power, network, or communication resources of the UE and network node that may have otherwise been consumed by detecting and correcting communication errors.

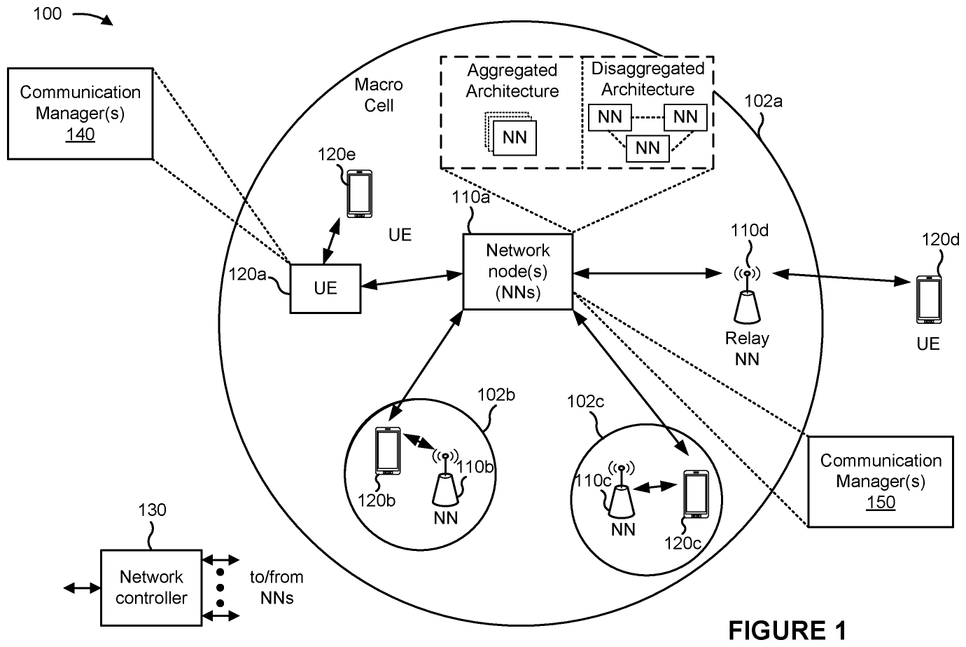

FIG. 1 is a diagram illustrating an example of a wireless network. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a user equipment (UE) 120 or multiple UEs 120 (shown as a UE 120a, a UE 120b, a UE 120c, a UE 120d, and a UE 120c), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an CNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses (for example, an augmented reality (AR), virtual reality (VR), mixed reality, or extended reality (XR) headset), a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium. Some UEs 120 (for example, UEs 102a and 120c) may communicate directly using one or more sidelink channels (for example, without a network node as an intermediary to communicate with one another).

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In some aspects, the UE 120 may include a communication manager 140. As described in more detail elsewhere herein, the communication manager 140 may transmit a first SRS associated with a first duplexing type and a second SRS associated with a second duplexing type that is different from the first duplexing type; receive an indication to transmit a data channel communication, the indication including an SRI associated with one or more parameters for transmission of the data channel communication; and transmit the data channel communication in a slot having the first duplexing type and using a configuration indicated via the SRI and associated with a most-recent SRS associated with the first duplexing type. Additionally, or alternatively, the communication manager 140 may perform one or more other operations described herein.

In some aspects, the network node 110 may include a communication manager 150. As described in more detail elsewhere herein, the communication manager 150 may receive a first SRS associated with a first duplexing type and a second SRS associated with a second duplexing type that is different from the first duplexing type; transmit an indication to transmit a data channel communication, the indication including an SRI associated with one or more parameters for transmission of the data channel communication; and receive the data channel communication in a slot having the first duplexing type and using a configuration indicated via the SRI and associated with a most-recent SRS associated with the first duplexing type. Additionally, or alternatively, the communication manager 150 may perform one or more other operations described herein.

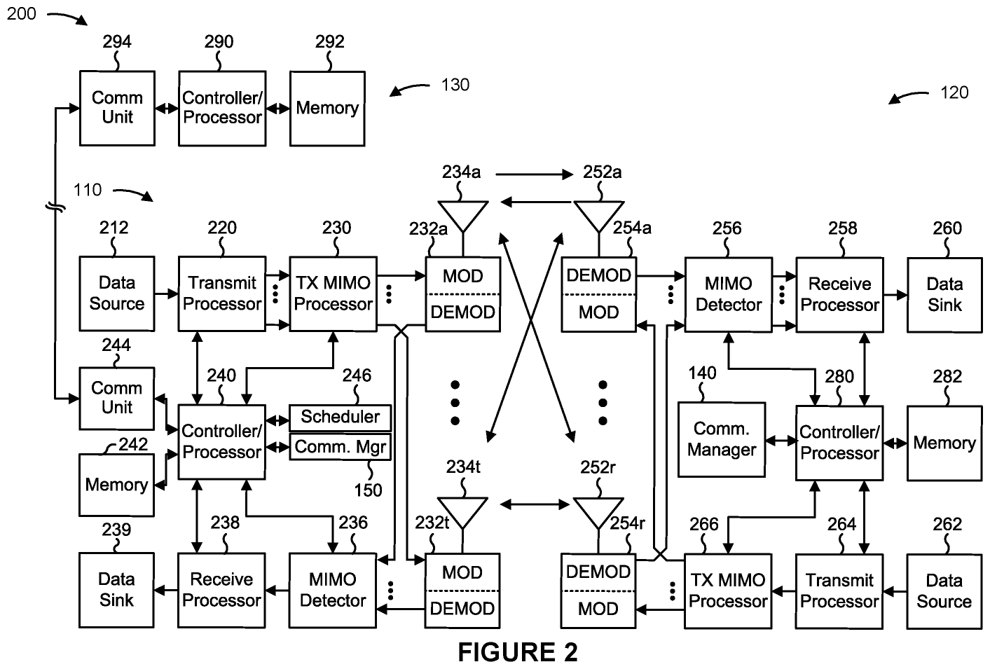

FIG. 2 is a diagram illustrating an example 200 of a network node in communication with a UE in a wireless network. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

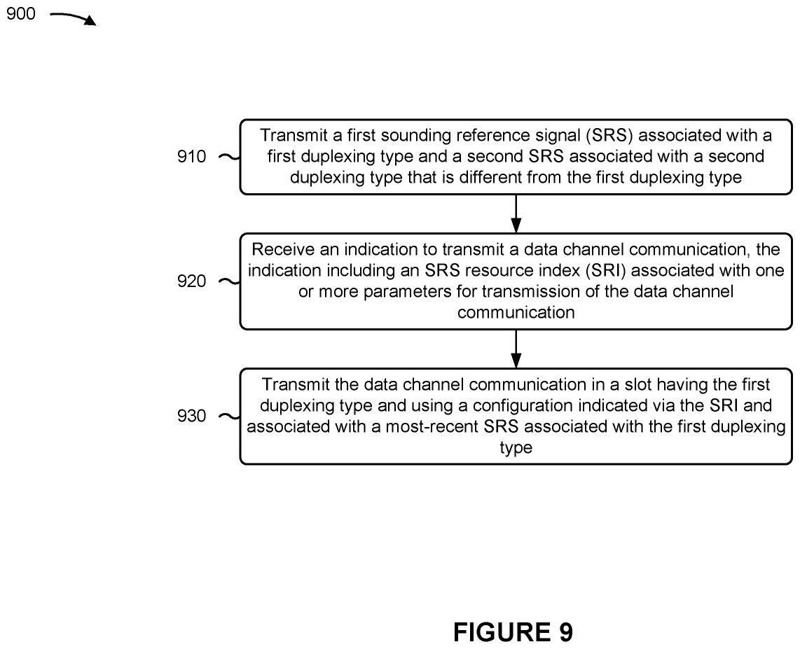

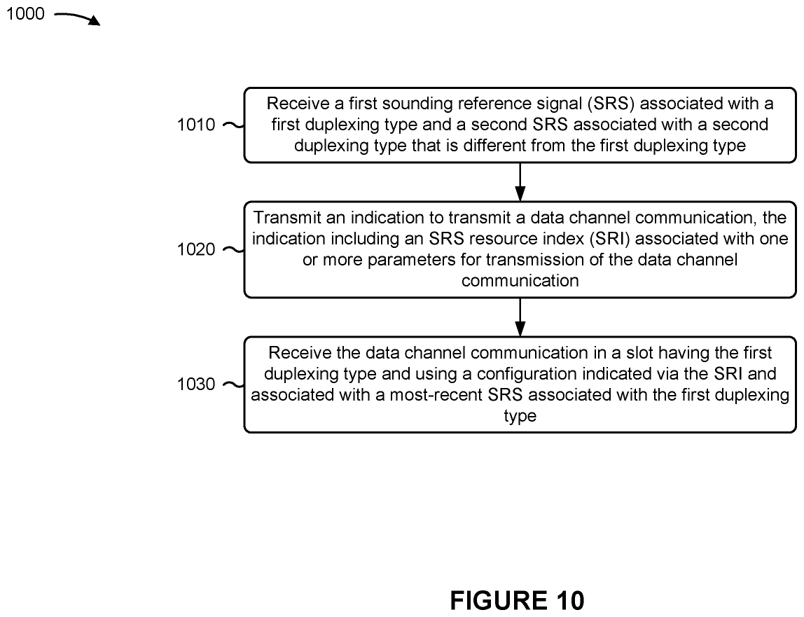

The controller/processor 240 of the network node 110, the controller/processor 280 of the UE 120, or any other component(s) of FIG. 2 may perform one or more techniques associated with SRIs with SRSs of different duplexing types, as described in more detail elsewhere herein. For example, the controller/processor 240 of the network node 110, the controller/processor 280 of the UE 120, or any other component(s) of FIG. 2 may perform or direct operations of, for example, process 900 of FIG. 9, process 1000 of FIG. 10, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 900 of FIG. 9, process 1000 of FIG. 10, or other processes as described herein. In some examples, executing instructions May include running the instructions, converting the instructions, compiling the instructions, or interpreting the instructions, among other examples.

In some implementations, one or more of the multiple memories may be configured to store processor-executable code that, when executed, may configure the one or more processors to perform various functions described herein (as part of a processing system). In some other implementations, the processing system may be pre-configured to perform various functions described herein.

In some aspects, the UE includes means for transmitting a first SRS associated with a first duplexing type and a second SRS associated with a second duplexing type that is different from the first duplexing type; means for receiving an indication to transmit a data channel communication, the indication including an SRI associated with one or more parameters for transmission of the data channel communication; and/or means for transmitting the data channel communication in a slot having the first duplexing type and using a configuration indicated via the SRI and associated with a most-recent SRS associated with the first duplexing type. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for receiving a first SRS associated with a first duplexing type and a second SRS associated with a second duplexing type that is different from the first duplexing type; means for transmitting an indication to transmit a data channel communication, the indication including an SRI associated with one or more parameters for transmission of the data channel communication; and/or means for receiving the data channel communication in a slot having the first duplexing type and using a configuration indicated via the SRI and associated with a most-recent SRS associated with the first duplexing type. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

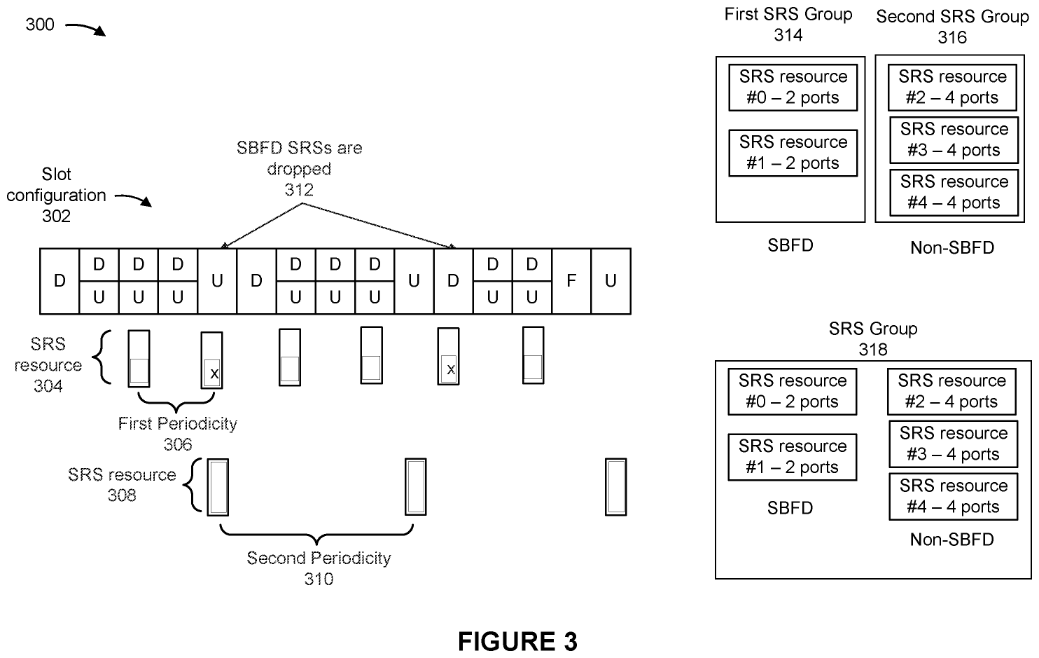

FIG. 3 is a diagram of an example 300 associated with SRSs in a network that supports subband full duplexing. In the context of FIG. 3, a UE (for example, UE 120) may communicate with a network node (for example, network node 110) using beamforming techniques. In some examples, the UE and the network node may communicate using a millimeter wave (mmW) frequency band or a higher frequency band.

As shown in FIG. 3, the UE and the network node may communicate using a slot configuration 302 that indicates which slots are scheduled for uplink (U) only, downlink (D) only, or for both uplink and downlink via subband full duplexing (SBFD).

The UE may be scheduled to transmit SRSs via SRS resource 304 associated with SBFD. The SRS resource 304 may have a first periodicity 306 for transmission of SRSs with SBFD. In some examples, the UE may transmit the SRSs associated with the SRS resource 304 via a subband that is configured for uplink during an SBFD slot.

The UE may be scheduled to transmit SRSs via SRS resource 308 associated with non-SBFD. The SRS resource 308 may have a second periodicity 310. For example, the SRS resource 308 may be configured with a periodicity 310 that is associated with uplink slots that are non-SBFD.

As shown by reference number 312, SBFD SRSs may be dropped when the SRS resource 304 indicates that the UE is to transmit the associated SRSs within a downlink slot, an uplink slot (non-SBFD), or an uplink slot that overlaps with a slot of the SRS resource 308.

In some examples, the SRS resource 304 and the SRS resource 308 may be selected from a set of candidate SRS resources. For example, the SRS resource 304 may be selected from a first SRS group 314 that includes SRS resources configured for SBFD. The SRS resource 308 may be selected from a second SRS group 316 that includes SRS resources configured for non-SBFD. In some examples, the SRS resource 304 and the SRS resource 308 may be selected from an SRS group 318 that includes SRS resources configured for SBFD and SRS resources configured for non-SBFD.

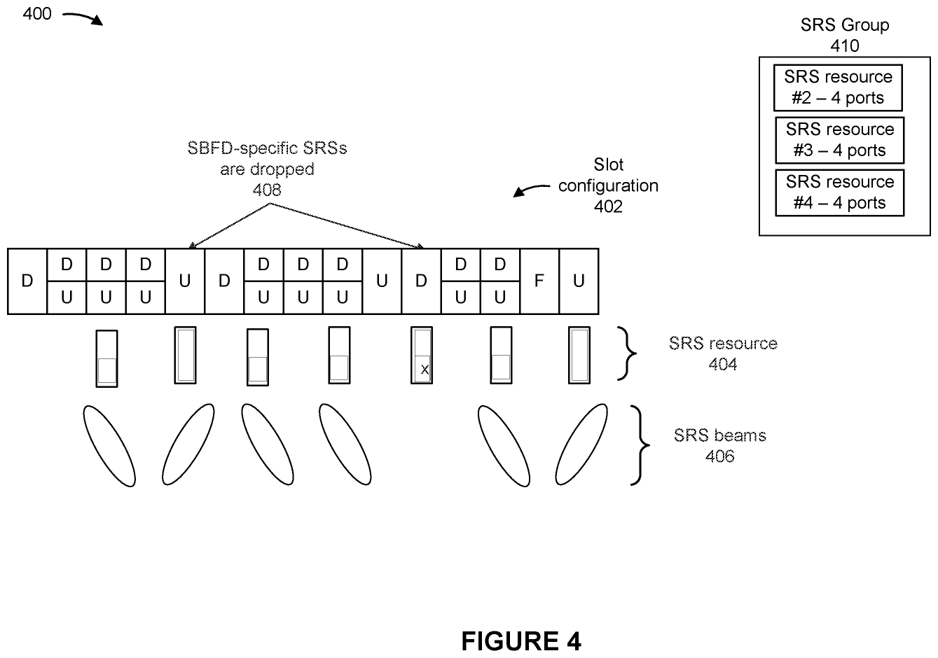

FIG. 4 is a diagram of an example 400 associated with SRSs in a network that supports subband full duplexing. In the context of FIG. 4, a UE (for example, UE 120) may communicate with a network node (for example, network node 110) using beamforming techniques. In some examples, the UE and the network node may communicate using a millimeter wave (mmW) frequency band or a higher frequency band.

In example 400, a slot configuration 402 indicates which slots are scheduled for uplink only, downlink only, or for both uplink and downlink via SBFD. The UE may be scheduled to transmit SRSs via a resource 404 that includes SRS frequency resources for SBFD and SRS frequency resources for non-SBFD. For example, the resource 404 is associated with a first frequency for transmission of SRSs when in an SBFD slot or with a second frequency for transmission of SRSs when in a non-SBFD slot. Additionally or alternatively, the resource 404 may be associated with different SRS beams 406 when in an SBFD slot or a non-SBFD slot. For example, the UE may use a first SRS beam when in an SBFD slot or a second beam when in a non-SBFD slot.

As shown by reference number 408, SBFD SRSs may be dropped when the SRS resource 404 indicates that the UE is to transmit the associated SRSs within an uplink slot (non-SBFD).

The SRS resource 404 may be selected from a set of candidate SRS resources of an SRS group 410. Candidate SRS resources of the set of candidate SRS resources may be associated with a number of ports used to transmit SRSs via a full band in a non-SBFD transmission.

Data channel communications, such as physical uplink shared channel (PUSCH) communications, may be configured as codebook (CB)-based transmissions, where a UE can be configured with only one SRS resource set with “usage” set to “codebook.” For CB-based transmissions, the UE may have a maximum quantity (for example, 4) SRS resources within the SRS resource set that can be configured. Each SRS resource may be RRC-configured with a number of ports (for example, nrofSRS-Ports). An SRI field in a DCI message (scheduling a PUSCH communication) indicates one SRS resource. A number of ports configured for the indicated SRS resource is associated with, or indicates, a number of antenna ports for the PUSCH communication. The UE transmits the PUSCH communication using a same spatial domain filter (for example, uplink beam) as the indicated SRS resource. A number of layers (rank) and TPMI for the PUSCH communication is determined from a separate DCI field, such as a “precoding information and number of layers” field.

Some data communications may be configured as non-codebook (NCB)-based transmissions. For non-CB-based transmissions, the UE may be configured with only one SRS resource set with “usage” set to “noncodebook.” The UE may have a maximum quantity (for example, 4) SRS resources within the SRS resource set that can be configured. Each SRS resource may be associated with one port for transmission. An SRI field in a DCI message (scheduling a PUSCH communication) may indicate one or more SRS resources. A quantity of indicated SRS resources indicates a rank (for example, a number of layers) for the scheduled PUSCH communication. The UE transmits the PUSCH communication a same spatial domain filter (for example, uplink beam) as the indicated SRS resource.

In both CB-based transmissions and non-CB-based transmissions, a size of an SRI field is a function of a number of SRS resources within the SRS resource set. The indicated SRI in slot n is associated with the most recent transmission of one or more SRS resources identified by the SRI, where the SRS transmission is prior to a physical downlink control channel (PDCCH) carrying the SRI.

However, in a network that supports transmission of SRSs via SBFD and via non-SBFD slots, an SRI may be used to indicate a configuration for the UE to use for transmission of a data channel communication using a reference to a most-recent SRS resource, whether or not the most-recent SRS resource has a same duplexing type as a slot used to transmit the data channel communication. In this way, the UE may transmit the data channel communication using transmission parameters, such as a spatial domain filter, that is best for a first duplexing type even though a second duplexing type is to be used to transmit the data channel communication. This may decrease SNR or SINR, or may increase an error rate associated with uplink communications in association with the transmission parameters being associated with a different duplexing type than the uplink communications. In increased error rate may cause the UE and the network node to retransmit communications, which may consume power, computing, network, or communication resources.

In some aspects described herein, a network node may transmit an SRI indicating an SRS from an SRS resource having a same duplexing type as a slot in which the data channel communication is scheduled. In some aspects, the SRI may indicate an SRS from an SRS resource that is not a most-recent SRS resource based on the most-recent SRS resource having a different duplexing type than the slot in which the data channel communication is scheduled. The UE may use the SRI to select an SRS from an SRS resource having a same duplexing type as the slot in which the data channel communication is scheduled.

In some examples, the described techniques can be used to improve transmission configurations in networks that support full duplexing. For example, by using the SRI to indicate one or more SRS resources having a same duplexing type as an uplink data channel communication, the SRI may indicate best transmission parameters associated with the duplexing type. By indicating the best transmission parameters associated with a duplexing type, the UE may be indicated to use the best transmission beam (for example, associated with a spatial domain filter) for a subband full duplexing data channel communication or for a non-subband-full-duplexing data channel communication. In this way, the network node may receive the data channel communication with improved SNR or SINR, and may improve an error rate of uplink communications from the UE, which may conserve computing, power, network, or communication resources of the UE and network node that may have otherwise been consumed by detecting and correcting communication errors.

In some examples, when two SRS resource sets with usage ‘codebook’ (or usage ‘non-codebook’) are configured (one for SRS transmission in SBFD and the other for SRS transmission for non-SBFD symbols), an SRI bitfield is associated with the most recent transmission of one or more SRS resources of a set with a same duplexing type of the slot for the ‘codebook’ or ‘non-codebook’ PUSCH. In some aspects, the duplex type may be implicitly determined or identified from a slot type of the PUSCH or may be identified explicitly (e.g., via a bitfield) within a scheduling DCI. In some aspects, an SRS specific set or resource may be associated with SBFD or non-SBFD symbols using explicit RRC signaling. In some aspects, a quantity of SRS resources of each SRS set and a quantity of ports within a same SRS resource may be same or different.

In some aspects, when a single SRS resource sets with usage ‘codebook’ (or usage ‘non-codebook’) is configured with M non-SBFD-specific SRS resources and N SBFD specific SRS resources, an SRI is interpreted with either the M or N resources based on a most-recent transmission of one or more SRS resources with a same duplex type as a transmission occasion of the PUSCH.

A size of a DCI bitfield that includes the SRI may be associated with the maximum size of N,M(N_SRS=max(N,M)). The SRI may be interpreted with N_{SRS}, N_{SRS(o_2)} being equal to N SRS resources or M SRS resources in associated with the duplex type of the scheduled PUSCH. This may apply to CB-based and non-CB-based PUSCH communications. In some aspects, the UE may identify the duplex type using an implicit indication associated with a slot type or using an explicit indication within the DCI message.

In some aspects where an SRS resource set has 5 SRS resources (N=3, M=2), the SRI bitfield may have a length that is ┌log₂ max(N,M)┐ for ‘codebook’ PUSCH communications. In this example, the SRI may have a length that is 2 bits. In a non-SBFD symbol, the SRI may use a table having 3 values, each associated with different SRS resources of the N resources. In an SBFD symbol, the SRI may use a table having 2 values, each associated with different SRS resources of the M, with the SRI bitfield being truncated to a most-significant bit (MSB) or a least-significant bit (LSB).

In some examples, the SRI may use a table that maps bit field indexes and SRIs. For example, the table may be associated with an SRI indication (or second SRI indication) for CB-based PUSCH transmission, where an uplink full power transmission (uplink-FullPowerTxn) is equal to a full power mode (fullpowerMode2) and N_{SRS} is 3. In this case each index may map to an SRS until no remaining SRSs are available (e.g., {0,0}, {1,1}, {2,2}, and {3, reserved}). In some examples, the table may be associated with an SRI indication (or second SRI indication) for CB-based PUSCH transmission, where an uplink full power transmission (uplink-FullPowerTxn) is not configured, is equal to a full power mode (fullpowerMode1, or fullpowerMode2), or is equal to full power, and N_{SRS} is 2. In this case each index may map to an SRS until no remaining SRSs are available (e.g., {0,0}, {1,1}).

In some aspects, an SRS set with usage ‘non-codebook’ may be associated with a set of downlink reference signals (RSs) (such as channel state information (CSI)-RSs) to determine an SRS precoder. To achieve uplink and downlink channel reciprocity, the ‘non-codebook’ SRS transmission may be associated with a CSI-RS (using N-ports), while SRS transmission in SBFD symbol may be associated with subset of ports of the CSI-RS (M-ports). The UE may receive the CSI-RS in a downlink slot from both antenna groups or panels of the network node while or may receive the CSI-RS in an SBFD slot from only one antenna group or panel (for example, using a subset of ports).

In some aspects when a single SRS set has usage ‘non-codebook’ configured, the SRS set may be associated with a single CSI-RS resource. For SRS transmission in SBFD symbols, the UE may consider only a subset of CSI-RS ports. The CSI-RS ports may be split into two groups of ports, such that for non-SBFD (for example, time domain duplexing) all ports are associated with the SRS and for SBFD only one group of the ports is used. The port grouping may be associated with code division multiplexing (CDM) groups. For example, half of the CDM groups (odd/even CDM groups, a first half, or a second half, among other examples) make one of the groups. Alternatively, only a subset of the ports in each CDM group form a group of the groups of ports.

In some aspects when a single SRS set has usage ‘non-codebook’ configured, the SRS set may be associated with up to two CSI-RS resources. The first CSI-RS resource is for SRS transmission in non-SBFD slots or symbols while the second CSI-RS resource is associated with SRS transmission in SBFD slots or symbols. In some aspects, a network node may configure a quantity of ports in the second CSI-RS resource to match a subset of antenna ports used for uplink reception in SBFD slots or symbols. In some aspects, the network node may configure time resources of the two CSI-RS to be overlapping or non-overlapping.

As example where two groups of ports are used, with one group associated with each antenna group or panel. Each antenna panel may be associated with 2 CDM groups, where 32 CSI-RS ports use 4 CDM groups that each has 8 ports. In some aspects, a first group of ports includes a first half (0 and 1) or a second half (2 and 3) of CDM groups and a second group of ports includes remaining CDM groups. In some aspects, the first group of ports includes even numbered CDM groups (0 and 2) and the second group of ports includes odd numbered CDM groups (1 and 3). In some aspects, the first group of ports includes a first portion of one or more CDM groups and the second group of ports includes a second portion of the one or more CDM groups. For example, ports 0-3 of each CDM group may be included in the first group that is mapped to the first antenna group or panel, and ports 4-7 of each CDM group may be included in the second group that is mapped to the second antenna group or panel.

In some aspects when two SRS sets with usage ‘non-codebook’ are configured, each SRS set may be associated with a downlink non-zero-power (NZP) CSI-RS.

In some aspects, the network node may include a set of co-located antenna groups or panels, or the network node may include a set of non-co-located antenna groups or panels of TRPs to provide SBFD communications with the UE. In this way, the UE may communicate with the network node via a first TRP and via a second TRP. For example, the UE may receive downlink communications via the first TRP and may transmit uplink communications via the second TRP. In some aspects, the UE may transmit uplink communications via the first TRP and may receive downlink communications via both the first TRP and the second TRP. In some aspects, the first TRP may have provide better performance for uplink communications when the UE is in SBFD and the second TRP may provide better performance for uplink communications with the UE is in non-SBFD. In this case, the UE may further improve uplink communications by supporting selection of communication parameters (e.g., a spatial domain filter) associated with an SRS that is associated with either the first beam (e.g., if the uplink communication is in SBFD) or the second beam (e.g., if the uplink communication is in non-SBD). Without mapping the SRI to the first TRP or the second TRP, and selecting an SRS associated with the mapped TRP, the SRI may be forced to select an SRS from a most-recent SRS resource, which may be associated with lower-quality parameters for the uplink communication (e.g., based on the most-recent SRS resources being associated with the less-efficient TRP).

In some aspects, the UE may be configured with two sets of SRSs for SBFD mode using non-co-located TRPs when using CB-based or non-CB-based communications. Each SRS set may be associated with an antenna group or TRP (each associated with a different control resource set (CORESET) group). In this way, each SRS group may be associated with a different antenna group or TRP, which may have different transmission or reception beams based on being non-co-located. The UE may support multiple TCI states, with at least one TCI state associated with a first TRP and at least one TCI state associated with a second TRP. In this way, the UE may group the SRS groups based on beams (e.g., groups of neighbor beams) and the SRI may indicate different beams within the groups of neighbor beams based on associated of the SRI with one of the groups of neighbor beams.

In an example, a first TRP may be a best-serving TRP for the UE within non-SBFD slots, and the UE uses a first set of SRSs for uplink or downlink CSI. The first TRP may be in downlink mode in an SBFD slot, and the UE may use a second set of SRSs for uplink CSI.

In another example, the first TRP may be a best-serving TRP for the UE within non-SBFD slots, and the UE uses the first set of SRSs for uplink or DCI CSI. A second TRP is in uplink mode in an SBFD slot, and the UE uses the first set of SRSs with a subset of RBs.

In some aspects, two SRS sets may be configured with usage ‘codebook,’ one for SRS transmission for each TRP. The SRI may be associated with the most recent transmission of one or more SRS resources of the set with a same duplex type. In some aspects, two SRS sets may be configured with usage ‘non-codebook,’ with one per each duplexing type. Each SRS set may be associated with a downlink RS from each TRP or antenna group or panel. The SRI may be associated with the most recent transmission of one or more SRS resources of the set with same duplex types.

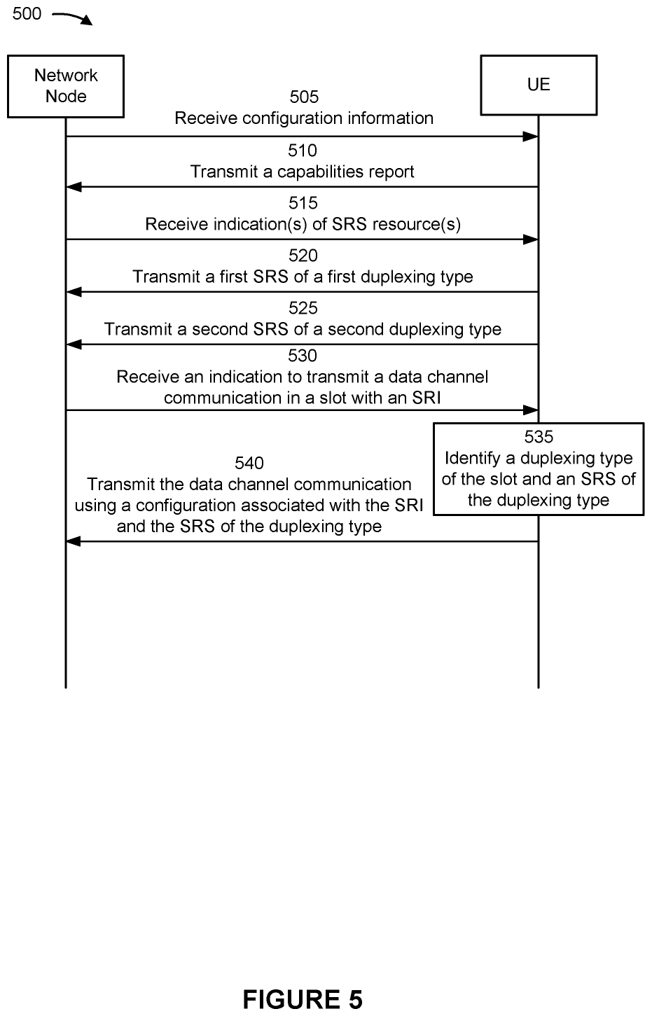

FIG. 5 is a diagram of an example 500 associated with SRIs with SRSs of different duplexing types. As shown in FIG. 5, a network node (for example, network node 110, a CU, a DU, and/or an RU) may communicate with a UE (for example, UE 120). In some aspects, the network node and the UE may be part of a wireless network (for example, wireless network 100). The UE and the network node may have established a wireless connection prior to operations shown in FIG. 5. In some aspects, the UE and the network node may communicate using beam forming. In some aspects, the UE and the network node may communicate using a frequency band that is a sub-6 GHz band, a mmW band, or a higher frequency domain band.

As shown by reference number 505, the network node may transmit, and the UE may receive, configuration information. In some aspects, the UE may receive the configuration information via one or more of RRC signaling, one or more MAC control elements (CEs), and/or DCI, among other examples. In some aspects, the configuration information may include an indication of one or more configuration parameters (for example, already known to the UE and/or previously indicated by the network node or other network device) for selection by the UE, and/or explicit configuration information for the UE to use to configure the UE, among other examples.

In some aspects, the configuration information may indicate that the UE is to communicate using SBFD resources. In some aspects, the configuration information may indicate that the UE is to apply an SRI to an SRS resources having a same duplexing type as a resource scheduled for transmission of a data channel communication.

The UE may configure itself based at least in part on the configuration information. In some aspects, the UE may be configured to perform one or more operations described herein based at least in part on the configuration information.

As shown by reference number 510, the UE may transmit, and the network node may receive, a capabilities report. In some aspects, the capabilities report may indicate UE support for identifying an SRS to use with an SRI in connection with a duplexing mode of a time resource used to transmit a data channel communication associated with the SRI.

As shown by reference number 515, the UE may receive, and the network node may transmit, one or more indications of one or more SRS resources for the UE to use to transmit SRSs. In some aspects, the UE may receive the one or more indications via a single message or via multiple messages. In some aspects, the UE may receive a first indication of a first set of SRS resources associated with the first duplexing type, or a second indication of a second set of SRS resources associated with the second duplexing type. In some aspects, the first set of SRS resources may be associated with a first quantity of SRS resources, the second set of SRS resources may be associated with a second quantity of SRS resources, and the first quantity of SRS resources is different from the second quantity of SRS resources. In some aspects, the first set of SRS resources may be associated with a first quantity of ports, the second set of SRS resources may be associated with a second quantity of ports, and the first quantity of ports is different from the second quantity of ports.

In some aspects, a first set of one or more SRSs may be configured for CB usage. In some aspects, a second set of one or more SRS may be configured for non-CB usage. In some aspects, all of the SRSs may be configured for either CB usage or for non-CB usage.

As shown by reference number 520, the UE may transmit, and the network node may receive, a first SRS of a first duplexing type.

As shown by reference number 525, the UE may transmit, and the network node may receive, a second SRS of a second duplexing type.

In some aspects, the first duplexing type or the second duplexing type includes SBFD. In some aspects, the first duplexing type or the second duplexing type includes non-SBFD. For example, the first duplexing type may be SBFD and the second duplexing type may be non-SBFD. Alternatively, the second duplexing type may be SBFD and the first duplexing type may be non-SBFD.

In some aspects, the first SRS may be part of a first SRS set and the second SRS may be part of a second SRS set. The first SRS set may be associated with a first duplexing type and the second SRS set may be associated with a second duplexing type that is different from the first duplexing type.

In some aspects, the first SRS and the second SRS may be within a single SRS resource set. The single SRS resource set may include a first quantity of SRS resources having the first duplexing type and a second quantity of SRS resources having the second duplexing type. In some aspects, the UE may identify the SRI with the first quantity of SRS resources in association with the slot having the first duplexing type.

In some aspects, the first SRS or the second SRS may be configured for non-CB usage and is associated with a CSI-RS resource. Transmitting the first SRS and the second SRS may include transmitting the first SRS in association with a subset of ports associated with a CSI-RS in association with the first duplexing type being SBFD. In some aspects, transmitting the first SRS and the second SRS may include transmitting the second SRS in association with a subset of ports associated with a CSI-RS in association with the second duplexing type being SBFD. In some aspects, the subset of ports includes a subset of CDM groups, such as a subset of lowest CDM groups, a subset of highest CDM groups, a subset of odd CDM groups, or a subset of even CDM groups, among other examples. In some aspects, the subset of ports includes a subset of ports within respective CDM groups.

In some aspects, the UE may transmit the first SRS in association with a first CSI-RS resource in association with the first duplexing type including SBFD. In some aspects, the UE may transmit the second SRS in association with a second CSI-RS resource in association with the second duplexing type including SBFD. In some aspects, the first SRS may be included in a first SRS set configured with a non-CB configuration, the second SRS may be included in a second SRS set configured with a non-CB configuration. The first SRS may be associated with the first CSI resource, the second SRS is associated with the second CSI resource in association with the first SRS set, and the second SRS set is configured with a non-codebook configuration.

In some aspects, the first SRS may be associated with a first CORESET identifier (or first TRP), and the second SRS may be associated with a second CORESET identifier (or second TRP that is non-co-located with the first TRP). In some aspects, the first SRS may be associated with a first downlink reference signal received in association with the first CORESET identifier. In some aspects, the second SRS may be associated with a second downlink reference signal received in association with the second CORESET identifier. In some aspects, SBFD includes communicating with a first TRP associated with the first SRS and communicating with a second TRP associated with the second SRS. The first TRP and the second TRPs may be associated with the network node, such that the network node may communicate with the UE via the first TRP and the second TRP.

As shown by reference number 530, the UE may receive, and the network node may transmit, an indication to transmit a data channel communication in a slot with an SRI. In some aspects, the SRI may be associated with, or may indicate, one or more parameters for transmission of the data channel communication. For example, the SRI may indicate an SRS having transmission parameters (such as a spatial domain filter) that the UE is to use to transmit the data channel communication.

In some aspects, the data channel communication may be configured for CB-based usage or non-CB-based usage. In some aspects, the UE may identify the SRS in association with the data channel communication being CB-based or non-CB based.

In some aspects, the network node may schedule the data channel communication via DCI, or may activate the data channel communication via MAC CE or an RRC configuration.

In some aspects, a size of an SRI bitfield associated with the SRI may be associated with a larger of a first quantity of SRS resources having the first duplexing type and a second quantity of SRS resources having the second duplexing type.

As shown by reference number 535, the UE may identify a duplexing type of the slot and an SRS of the duplexing type. In some aspects, the UE may identify the SRS to use in connection with the SRI to identify transmission parameters for the data channel communication. In some aspects, the SRS may be a most-recent SRS or may be a most-recent SRS having the same duplexing type as the slot (which may not be a most-recent SRS).

In some aspects, the UE may identify the duplexing type of the slot and that the duplexing type is the same as the SRS used to identify transmission parameters for the data channel communication. For example, the UE may identify the slot as having the same duplexing type as the SRS based on an implicit indication of the slot type of the slot (for example, a duplexing type) or based on an indication from the network node (for example, within a field of a message that includes the indication to transmit the data channel communication).

In some aspects, the UE may identify the SRI as associated with an SRS resources based on the duplexing type and whether the data channel communication is a codebook or a non-codebook communication.

In some aspects, the UE may identify the SRI with a first quantity of SRS resources in association with the slot having the first duplexing type. In some aspects, the UE may interpret the SRI bitfield using least significant bits or most significant bits of the SRI bitfield in association with the SRI being associated with SRS resources having a quantity that is less than unique values of the SRI bitfield. For example, the UE may ignore one or more bits of the SRI bitfield based on a quantity of unique values of the SRI bitfield being greater than a number of SRSs having a same duplexing type as the slot scheduled with the data channel communication.

In some aspects, the SRI may indicate a first group of SRSs or an SRS index associated with a first TRP or may indicate a second group of SRSs or an SRS index associated with a second SRS. The first TRP may have provide better performance for uplink communications when the UE is in SBFD and the second TRP may provide better performance for uplink communications with the UE is in non-SBFD. In this case, the UE may further improve uplink communications by supporting selection of communication parameters (e.g., a spatial domain filter) associated with an SRS that is associated with either the first beam (e.g., if the uplink communication is in SBFD) or the second beam (e.g., if the uplink communication is in non-SBD). Without mapping the SRI to the first TRP or the second TRP, and selecting an SRS associated with the mapped TRP, the SRI may be forced to select an SRS from a most-recent SRS resource, which may be associated with lower-quality parameters for the uplink communication (e.g., based on the most-recent SRS resources being associated with the less-efficient TRP).

In some aspects, the UE may be configured with two sets of SRSs for SBFD mode using non-co-located TRPs when using CB-based or non-CB-based communications. Each SRS set may be associated with an antenna group or TRP (each associated with a different control resource set (CORESET) group). In this way, each SRS group may be associated with a different antenna group or TRP, which may have different transmission or reception beams based on being non-co-located. The UE may support multiple TCI states, with at least one TCI state associated with a first TRP and at least one TCI state associated with a second TRP. In this way, the UE may group the SRS groups based on beams (e.g., groups of neighbor beams) and the SRI may indicate different beams within the groups of neighbor beams based on associated of the SRI with one of the groups of neighbor beams.

As shown by reference number 540, the UE may transmit, and the network node may receive, the data channel communication using a configuration associated with the SRI and the SRS of the duplexing type. In some aspects, the UE may transmit the data channel communication in a slot having the same duplexing type as the SRS. In some aspects, the configuration may be associated with a most-recent SRS associated with the first duplexing type.

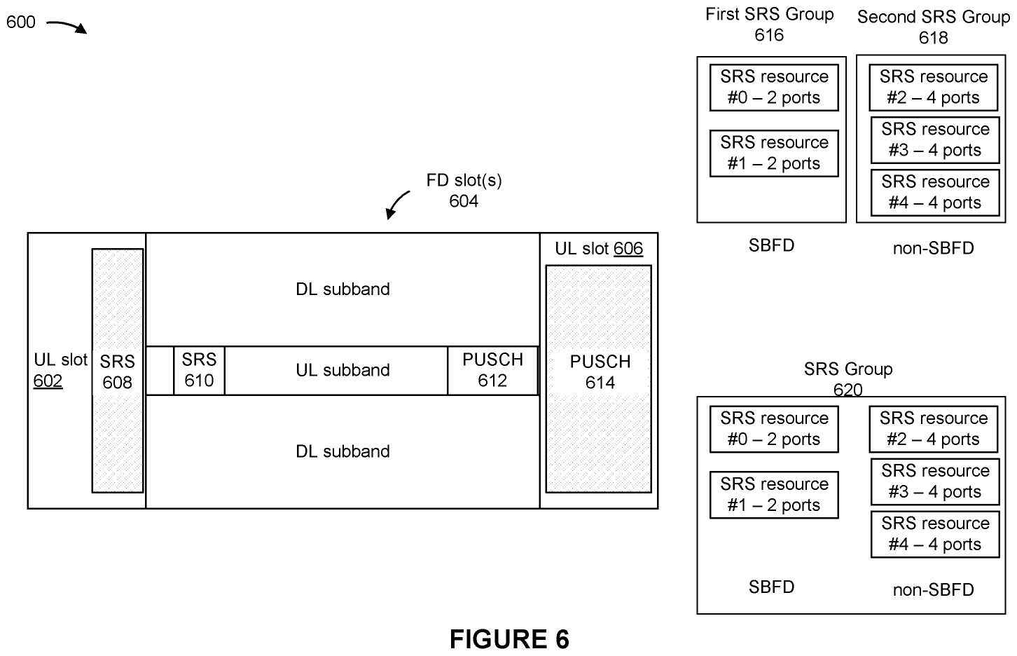

FIG. 6 is a diagram of an example 600 associated with SRSs having different duplexing types in a network that supports SBFD. In the context of FIG. 6, a UE (for example, UE 120) may communicate with a network node (for example, network node 110) using beamforming techniques. In some examples, the UE and the network node may communicate using a mmW frequency band or a higher frequency band.

As shown in FIG. 6, the UE may be configured with an uplink slot 602, one or more full duplexing (FD) slots 604, and an uplink slot 606. The UE may transmit an SRS 608 via the uplink slot 602. The first SRS may use a relatively wide bandwidth. The UE may transmit an SRS 610 via the one or more full duplexing slots 604 within an uplink subband of the one or more full duplexing slots 604. The one or more full duplexing slots 604 may include SBFD slots (e.g., may include one or more SBFD symbols).

The UE may transmit a PUSCH communication 612 via the one or more full duplexing slots 604 and within the uplink subband. In some aspects, the UE may use a configuration associated with an SRS of the SRS 610 based on the PUSCH communication 612 having a same duplexing type as the SRS 610 (both are full duplexing types).

The UE may transmit a PUSCH communication 614 via the uplink slot 606. In some aspects, the UE may use a configuration associated with an SRS of the SRS 608 based on the PUSCH communication 614 having a same duplexing type as the SRS 608 (both are non-full-duplexing types). In this way, the network node may indicate a configuration associated with the SRS 608 rather than the SRS 610. This may allow the network node to indicate a transmission configuration that is best for non-full-duplexing rather than a transmission configuration that is best for full-duplexing, when the associated PUSCH communication 614 is a non-full-duplexing communication.

In some examples, an SRS resource associated with the SRS 608 and an SRS resource associated with the SRS 610 may be selected from a set of candidate SRS resources. For example, the SRS resources may be selected from a first SRS group 616 that includes SRS resources configured for SBFD or from a second SRS group 618 that includes SRS resources configured for non-SBFD. In some examples, the SRS resources may be selected from an SRS group 620 that includes SRS resources configured for SBFD and SRS resources configured for non-SBFD.

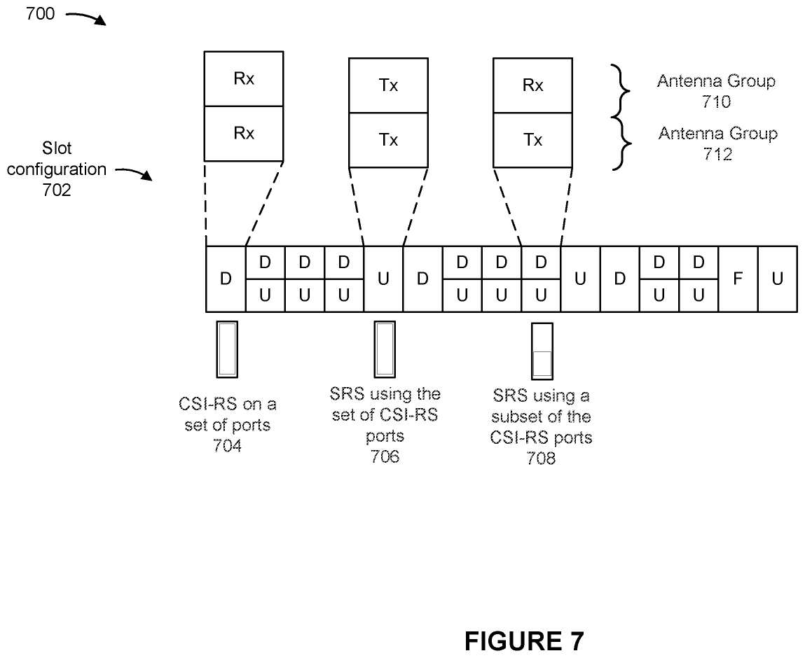

FIG. 7 is a diagram of an example 700 associated with SRSs having different duplexing types in a network that supports SBFD in context of non-codebook SRSs. In the context of FIG. 7, a UE (for example, UE 120) may communicate with a network node (for example, network node 110) using beamforming techniques. In some examples, the UE and the network node may communicate using a mmW frequency band or a higher frequency band.

As shown in FIG. 7, the UE and the network node may communicate using a slot configuration 702. In a downlink slot, the UE may receive CSI-RS 704 on a set of ports. Based on using non-CB SRSs, the UE may use the CSI-RSs to identify transmission parameters for transmitting the non-CB SRSs. For example, in a non-SBFD slot, the UE may transmit SRS 706 using the set of CSI-RS ports of the CSI-RS 704. This may be based on the UE using a full set of ports to receive the CSI-RS 704 and to transmit the SRS 706.

The UE may transmit SRS 708 using a subset of the CSI-RS ports based on a slot being an SBFD slot. This may allow the UE to transmit the SRSs using an antenna group 710 to receive a communication or RSs from the network node while transmitting the SRSs via an antenna group 712 within the same slot.

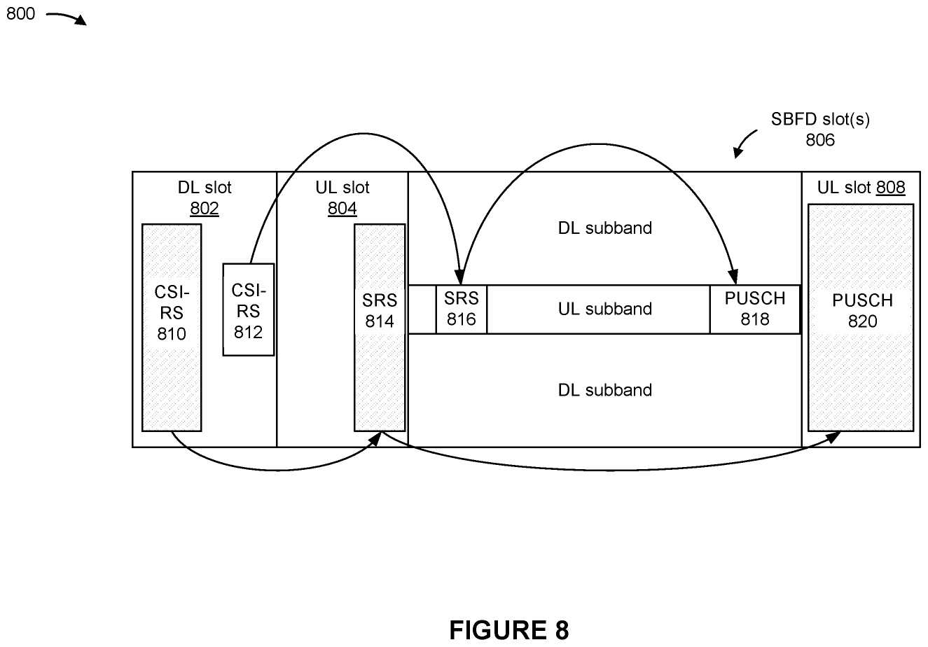

FIG. 8 is a diagram of an example 800 associated with SRSs having different duplexing types in a network that supports SBFD in context of non-codebook SRSs. In the context of FIG. 8, a UE (for example, UE 120) may communicate with a network node (for example, network node 110) using beamforming techniques. In some examples, the UE and the network node may communicate using a mmW frequency band or a higher frequency band.

As shown in FIG. 8, the UE may be configured with a downlink slot 802, an uplink slot 804, one or more FD slots 806, and an uplink slot 808. The UE may receive a CSI-RS 810 associated with non-SBFD and a CSI-RS 812 associated with SBFD within the downlink slot 802. The one or more FD slots 806 may include SBFD slots (e.g., may include one or more SBFD symbols).

The UE may transmit an SRS 814 within the uplink slot 804. The SRS 814 may use a configuration associated with reception of the CSI-RS 810 based on the SRS 814 being within a non-SBFD slot. For example, the UE may use a first set (a full set) of antenna groups or panels to receive the CSI-RS 810 and to transmit the SRS 814.

The UE may transmit an SRS 816 within the one or more SBFD slots 806 and within an uplink subband. The SRS 816 may use a configuration associated with reception of the CSI-RS 812 based on the SRS 816 being within a non-SBFD slot. For example, the UE may use a subset (less than a full set used for SRS 814) of antenna groups or panels to receive the CSI-RS 812 and to transmit the SRS 816.

The UE may transmit a PUSCH communication 818 via the one or more full duplexing slots 806 and within the uplink subband. In some aspects, the UE may use a configuration associated with an SRS of the SRS 816 based on the PUSCH communication 818 having a same duplexing type as the SRS 816 (both are full duplexing types).

The UE may transmit a PUSCH communication 820 via the uplink slot 808. In some aspects, the UE may use a configuration associated with an SRS of the SRS 814 based on the PUSCH communication 820 having a same duplexing type as the SRS 814 (both are non-full-duplexing types). In this way, the network node may indicate a configuration associated with the SRS 814 rather than the SRS 816. This may allow the network node to indicate a transmission configuration that is best for non-full-duplexing rather than a transmission configuration that is best for full-duplexing, when the associated PUSCH communication 820 is a non-full-duplexing communication.

FIG. 9 is a flowchart illustrating an example process 900 performed, for example, by a UE that supports SRIs that can indicate SRSs based on duplexing types. Example process 900 is an example where the UE (for example, UE 120) performs operations associated with SRIs with SRSs of different duplexing types.

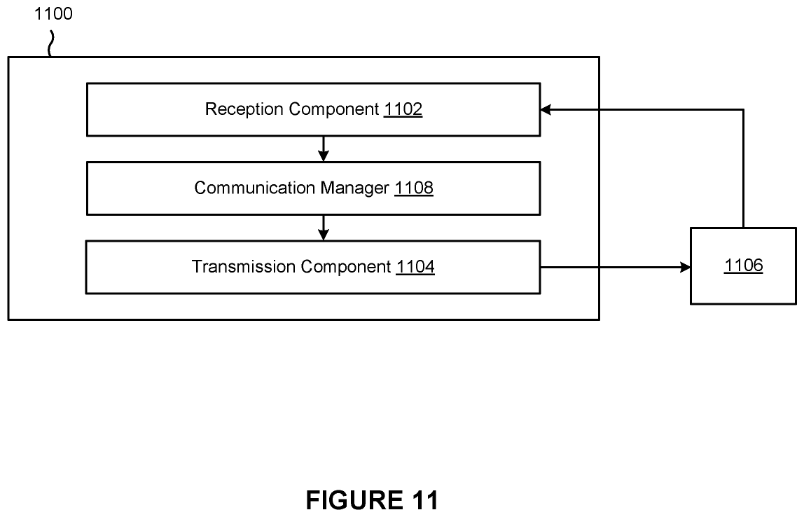

As shown in FIG. 9, in some aspects, process 900 may include transmitting a first SRS associated with a first duplexing type and a second SRS associated with a second duplexing type that is different from the first duplexing type (block 910). For example, the UE (such as by using communication manager 140 or transmission component 1104, depicted in FIG. 11) may transmit a first SRS associated with a first duplexing type and a second SRS associated with a second duplexing type that is different from the first duplexing type, as described above.

As further shown in FIG. 9, in some aspects, process 900 may include receiving an indication to transmit a data channel communication, the indication including an SRI associated with one or more parameters for transmission of the data channel communication (block 920). For example, the UE (such as by using communication manager 140 or reception component 1102, depicted in FIG. 11) may receive an indication to transmit a data channel communication, the indication including an SRI associated with one or more parameters for transmission of the data channel communication, as described above.

As further shown in FIG. 9, in some aspects, process 900 may include transmitting the data channel communication in a slot having the first duplexing type and using a configuration indicated via the SRI and associated with a most-recent SRS associated with the first duplexing type (block 930). For example, the UE (such as by using communication manager 140 or transmission component 1104, depicted in FIG. 11) may transmit the data channel communication in a slot having the first duplexing type and using a configuration indicated via the SRI and associated with a most-recent SRS associated with the first duplexing type, as described above.

Process 900 may include additional aspects, such as any single aspect or any combination of aspects described below or in connection with one or more other processes described elsewhere herein.

In a first additional aspect, the first duplexing type or the second duplexing type comprises subband full duplexing.

In a second additional aspect, alone or in combination with the first aspect, the first duplexing type or the second duplexing type comprises non-subband-full-duplexing.

In a third additional aspect, alone or in combination with one or more of the first and second aspects, process 900 includes identifying the slot as having first duplexing type in accordance with one or more of a slot type of the slot, or a field within the indication to transmit the data channel communication.

In a fourth additional aspect, alone or in combination with one or more of the first through third aspects, process 900 includes receiving one or more of a first indication of a first set of SRS resources associated with the first duplexing type and including the first SRS, or a second indication of a second set of SRS resources associated with the second duplexing type and including the second SRS.

In a fifth additional aspect, alone or in combination with one or more of the first through fourth aspects, the first set of SRS resources is associated with one or more of a first quantity of SRS resources or a first quantity of ports, wherein the second set of SRS resources is associated with one or more of a second quantity of SRS resources or a second quantity of ports, and wherein the first quantity of SRS resources is different from the second quantity of SRS resources, or the first quantity of ports is different from the second quantity of ports.

In a sixth additional aspect, alone or in combination with one or more of the first through fifth aspects, process 900 includes identifying the SRI associated with the SRS resources of the first SRS resource in association with the first duplexing type and whether the data channel communication is a codebook or a non-codebook communication.

In a seventh additional aspect, alone or in combination with one or more of the first through sixth aspects, the first SRS and the second SRS are configured for codebook or for non-codebook usage.

In an eighth additional aspect, alone or in combination with one or more of the first through seventh aspects, the data channel communication is configured for codebook-based PUSCH transmission or non-codebook based PUSCH transmission.

In a ninth additional aspect, alone or in combination with one or more of the first through eighth aspects, the data channel communication is scheduled or activated by one or more of DCI, a MAC-CE, or a RRC configuration.

In a tenth additional aspect, alone or in combination with one or more of the first through ninth aspects, the first SRS and the second SRS are within a single SRS resource set, wherein the single SRS resource set includes a first quantity of SRS resources having the first duplexing type and a second quantity of SRS resources having the second duplexing type, and wherein the UE identifies the SRI with the first quantity of SRS resources in association with the slot having the first duplexing type.

In an eleventh additional aspect, alone or in combination with one or more of the first through tenth aspects, a size of an SRI bitfield associated with the SRI is associated with a larger of the first quantity or the second quantity.

In a twelfth additional aspect, alone or in combination with one or more of the first through eleventh aspects, an SRI bitfield is interpreted using least significant bits or most significant bits of the SRI bitfield in association with the SRI being associated with SRS resources having a quantity that is less than unique values of the SRI bitfield.

In a thirteenth additional aspect, alone or in combination with one or more of the first through twelfth aspects, one or more of the first SRS or the second SRS is configured for non-codebook usage and is associated with a CSI-RS resource, and wherein transmitting the first SRS and the second SRS comprises transmitting the first SRS in association with a subset of ports associated with a CSI-RS in association with the first duplexing type comprising subband full duplexing, or transmitting the second SRS in association with a subset of ports associated with a CSI-RS in association with the second duplexing type comprising subband full duplexing.

In a fourteenth additional aspect, alone or in combination with one or more of the first through thirteenth aspects, the subset of ports comprises a subset of CDM groups, or wherein the subset of ports comprises a subset of ports within respective CDM groups.

In a fifteenth additional aspect, alone or in combination with one or more of the first through fourteenth aspects, transmitting the first SRS and the second SRS comprises transmitting the first SRS in association with a first CSI-RS resource in association with the first duplexing type comprising subband full duplexing, or transmitting the second SRS in association with a second CSI-RS resource in association with the second duplexing type comprising subband full duplexing.

In a sixteenth additional aspect, alone or in combination with one or more of the first through fifteenth aspects, the first SRS is included in a first SRS set configured with a non-codebook configuration, wherein the second SRS is included in a second SRS set configured with a non-codebook configuration, and wherein the first SRS is associated with the first CSI resource and the second SRS is associated with the second CSI resource in association with the first SRS set and the second SRS set being configured with a non-codebook configuration.

In a seventeenth additional aspect, alone or in combination with one or more of the first through sixteenth aspects, the first SRS is associated with a first CORESET identifier, and wherein the second SRS is associated with a second CORESET identifier.

In an eighteenth additional aspect, alone or in combination with one or more of the first through seventeenth aspects, the first SRS is associated with a first downlink reference signal received in association with the first CORESET identifier, and wherein the second SRS is associated with a second downlink reference signal received in association with the second CORESET identifier.

In a nineteenth additional aspect, alone or in combination with one or more of the first through eighteenth aspects, one or more of the first duplexing type or the second duplexing type comprises subband full duplexing, wherein the subband full duplexing comprises communicating with a first TRP associated with the first SRS and communicating with a second TRP associated with the second SRS.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a flowchart illustrating an example process 1000 performed, for example, by a network node that supports SRIs that can indicate SRSs based on duplexing types. Example process 1000 is an example where the UE (for example, UE 120) performs operations associated with SRI with SRSs of different duplexing types.

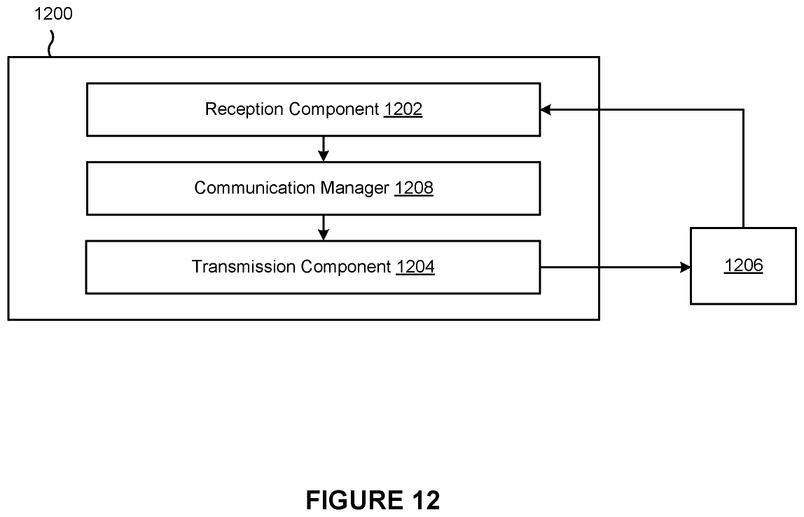

As shown in FIG. 10, in some aspects, process 1000 may include receiving a first SRS associated with a first duplexing type and a second SRS associated with a second duplexing type that is different from the first duplexing type (block 1010). For example, the network node (such as by using communication manager 150 or reception component 1202, depicted in FIG. 12) may receive a first SRS associated with a first duplexing type and a second SRS associated with a second duplexing type that is different from the first duplexing type, as described above.

As further shown in FIG. 10, in some aspects, process 1000 may include transmitting an indication to transmit a data channel communication, the indication including an SRI associated with one or more parameters for transmission of the data channel communication (block 1020). For example, the network node (such as by using communication manager 150 or transmission component 1204, depicted in FIG. 12) may transmit an indication to transmit a data channel communication, the indication including an SRI associated with one or more parameters for transmission of the data channel communication, as described above.

As further shown in FIG. 10, in some aspects, process 1000 may include receiving the data channel communication in a slot having the first duplexing type and using a configuration indicated via the SRI and associated with a most-recent SRS associated with the first duplexing type (block 1030). For example, the network node (such as by using communication manager 150 or reception component 1202, depicted in FIG. 12) may receive the data channel communication in a slot having the first duplexing type and using a configuration indicated via the SRI and associated with a most-recent SRS associated with the first duplexing type, as described above.

Process 1000 may include additional aspects, such as any single aspect or any combination of aspects described below or in connection with one or more other processes described elsewhere herein.

In a first additional aspect, the first duplexing type or the second duplexing type comprises subband full duplexing.

In a second additional aspect, alone or in combination with the first aspect, the first duplexing type or the second duplexing type comprises non-subband-full-duplexing.

In a third additional aspect, alone or in combination with one or more of the first and second aspects, the slot has a first duplexing type in accordance with one or more of a slot type of the slot, or a field within the indication to transmit the data channel communication.

In a fourth additional aspect, alone or in combination with one or more of the first through third aspects, process 1000 includes transmitting one or more of a first indication of a first set of SRS resources associated with the first duplexing type and including the first SRS, or a second indication of a second set of SRS resources associated with the second duplexing type and including the second SRS.

In a fifth additional aspect, alone or in combination with one or more of the first through fourth aspects, the first set of SRS resources is associated with one or more of a first quantity of SRS resources or a first quantity of ports, wherein the second set of SRS resources is associated with one or more of a second quantity of SRS resources or a second quantity of ports, and wherein the first quantity of SRS resources is different from the second quantity of SRS resources, or the first quantity of ports is different from the second quantity of ports.

In a sixth additional aspect, alone or in combination with one or more of the first through fifth aspects, the SRI is associated with the SRS resources of the first SRS resource in association with the first duplexing type and whether the data channel communication is a codebook or a non-codebook communication.

In a seventh additional aspect, alone or in combination with one or more of the first through sixth aspects, the first SRS and the second SRS are configured for codebook or for non-codebook usage.

In an eighth additional aspect, alone or in combination with one or more of the first through seventh aspects, the data channel communication is configured for codebook-based PUSCH transmission or non-codebook based PUSCH transmission.

In a ninth additional aspect, alone or in combination with one or more of the first through eighth aspects, the data channel communication is scheduled or activated by one or more of DCI, a MAC CE, or a RRC configuration.

In a tenth additional aspect, alone or in combination with one or more of the first through ninth aspects, the first SRS and the second SRS are within a single SRS resource set, wherein the single SRS resource set includes a first quantity of SRS resources having the first duplexing type and a second quantity of SRS resources having the second duplexing type, and wherein the UE identifies the SRI with the first quantity of SRS resources in association with the slot having the first duplexing type.

In an eleventh additional aspect, alone or in combination with one or more of the first through tenth aspects, a size of an SRI bitfield associated with the SRI is associated with a larger of the first quantity or the second quantity.

In a twelfth additional aspect, alone or in combination with one or more of the first through eleventh aspects, an SRI bitfield is interpreted using least significant bits or most significant bits of the SRI bitfield in association with the SRI being associated with SRS resources having a quantity that is less than unique values of the SRI bitfield.

In a thirteenth additional aspect, alone or in combination with one or more of the first through twelfth aspects, one or more of the first SRS or the second SRS is configured for non-codebook usage and is associated with a CSI-RS resource, and wherein receiving the first SRS and the second SRS comprises transmitting the first SRS in association with a subset of ports associated with a CSI-RS in association with the first duplexing type comprising subband full duplexing, or transmitting the second SRS in association with a subset of ports associated with a CSI-RS in association with the second duplexing type comprising subband full duplexing.

In a fourteenth additional aspect, alone or in combination with one or more of the first through thirteenth aspects, the subset of ports comprises a subset of CDM groups, or wherein the subset of ports comprises a subset of ports within respective CDM groups.

In a fifteenth additional aspect, alone or in combination with one or more of the first through fourteenth aspects, receiving the first SRS and the second SRS comprises receiving the first SRS in association with a first CSI-RS resource in association with the first duplexing type comprising subband full duplexing, or receiving the second SRS in association with a second CSI-RS resource in association with the second duplexing type comprising subband full duplexing.

In a sixteenth additional aspect, alone or in combination with one or more of the first through fifteenth aspects, the first SRS is included in a first SRS set configured with a non-codebook configuration, wherein the second SRS is included in a second SRS set configured with a non-codebook configuration, and wherein the first SRS is associated with the first CSI resource and the second SRS is associated with the second CSI resource in association with the first SRS set and the second SRS set being configured with a non-codebook configuration.

In a seventeenth additional aspect, alone or in combination with one or more of the first through sixteenth aspects, the first SRS is associated with a first CORESET identifier, and wherein the second SRS is associated with a second CORESET identifier.

In an eighteenth additional aspect, alone or in combination with one or more of the first through seventeenth aspects, the first SRS is associated with a first downlink reference signal received in association with the first CORESET identifier, and wherein the second SRS is associated with a second downlink reference signal received in association with the second CORESET identifier.

In a nineteenth additional aspect, alone or in combination with one or more of the first through eighteenth aspects, one or more of the first duplexing type or the second duplexing type comprises subband full duplexing, wherein the subband full duplexing comprises communicating via a first TRP associated with the first SRS and communicating via a second TRP associated with the second SRS.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a diagram of an example apparatus 1100 for wireless communication that supports SRIs that can indicate SRSs based on duplexing types. The apparatus 1100 may be a UE, or a UE may include the apparatus 1100. In some aspects, the apparatus 1100 includes a reception component 1102, a transmission component 1104, and a communication manager 1108 (for example, communication manager 140), which may be in communication with one another (for example, via one or more buses). As shown, the apparatus 1100 may communicate with another apparatus 1106 (such as a UE, a network node, or another wireless communication device) using the reception component 1102 and the transmission component 1104.

In some aspects, the apparatus 1100 may be configured to and/or operable to perform one or more operations described herein in connection with FIGS. 5-8. Additionally or alternatively, the apparatus 1100 may be configured to and/or operable to perform one or more processes described herein, such as process 900 of FIG. 9. In some aspects, the apparatus 1100 may include one or more components of the UE described above in connection with FIG. 2.

The reception component 1102 may receive communications, such as reference signals, control information, and/or data communications, from the apparatus 1106. The reception component 1102 may provide received communications to one or more other components of the apparatus 1100, such as the communication manager 1108. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1102 may include one or more antennas, a modem, a demodulator, a MIMO detector, a receive processor, a controller/processor, and/or a memory of the UE described above in connection with FIG. 2.

The transmission component 1104 may transmit communications, such as reference signals, control information, and/or data communications, to the apparatus 1106. In some aspects, the communication manager 1108 may generate communications and may transmit the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, and/or a memory of the UE described above in connection with FIG. 2. In some aspects, the transmission component 1104 may be co-located with the reception component 1102 in a transceiver.

The communication manager 1108 may transmit or may cause the transmission component 1104 to transmit a first SRS associated with a first duplexing type and a second SRS associated with a second duplexing type that is different from the first duplexing type. The communication manager 1108 may receive or may cause the reception component 1102 to receive an indication to transmit a data channel communication, the indication including an SRI associated with one or more parameters for transmission of the data channel communication. The communication manager 1108 may transmit or may cause the transmission component 1104 to transmit the data channel communication in a slot having the first duplexing type and using a configuration indicated via the SRI and associated with a most-recent SRS associated with the first duplexing type. In some aspects, the communication manager 1108 may perform one or more operations described elsewhere herein as being performed by one or more components of the communication manager 1108.

The communication manager 1108 may include a controller/processor, a memory, a scheduler, and/or a communication unit of the UE described above in connection with FIG. 2. In some aspects, the communication manager 1108 includes a set of components, such as an identification component. Alternatively, the set of components may be separate and distinct from the communication manager 1108. In some aspects, one or more components of the set of components may include or may be implemented within a controller/processor, a memory, a scheduler, and/or a communication unit of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1104 may transmit a first SRS associated with a first duplexing type and a second SRS associated with a second duplexing type that is different from the first duplexing type. The reception component 1102 may receive an indication to transmit a data channel communication, the indication including an SRI associated with one or more parameters for transmission of the data channel communication. The transmission component 1104 may transmit the data channel communication in a slot having the first duplexing type and using a configuration indicated via the SRI and associated with a most-recent SRS associated with the first duplexing type.

The communication manager 1108 may identify the slot as having first duplexing type in accordance with one or more of a slot type of the slot, or a field within the indication to transmit the data channel communication.

The reception component 1102 may receive one or more of a first indication of a first set of SRS resources associated with the first duplexing type and including the first SRS, or a second indication of a second set of SRS resources associated with the second duplexing type and including the second SRS.

The communication manager 1108 may identify the SRI associated with the SRS resources of the first SRS resource in association with the first duplexing type and whether the data channel communication is a codebook or a non-codebook communication.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

FIG. 12 is a diagram of an example apparatus 1200 for wireless communication that supports SRIs that can indicate SRSs based on duplexing types. The apparatus 1200 may be a network node, or a network node may include the apparatus 1200. In some aspects, the apparatus 1200 includes a reception component 1202, a transmission component 1204, and a communication manager 1208 (for example, communication manager 150), which may be in communication with one another (for example, via one or more buses). As shown, the apparatus 1200 may communicate with another apparatus 1206 (such as a UE, a network node, or another wireless communication device) using the reception component 1202 and the transmission component 1204.

In some aspects, the apparatus 1200 may be configured to and/or operable to perform one or more operations described herein in connection with FIGS. 5-8. Additionally or alternatively, the apparatus 1200 may be configured to and/or operable to perform one or more processes described herein, such as process 1000 of FIG. 10. In some aspects, the apparatus 1200 may include one or more components of the network node described above in connection with FIG. 2.

The reception component 1202 may receive communications, such as reference signals, control information, and/or data communications, from the apparatus 1206. The reception component 1202 may provide received communications to one or more other components of the apparatus 1200, such as the communication manager 150. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, a modem, a demodulator, a MIMO detector, a receive processor, a controller/processor, and/or a memory of the network node described above in connection with FIG. 2.

The transmission component 1204 may transmit communications, such as reference signals, control information, and/or data communications, to the apparatus 1206. In some aspects, the communication manager 150 may generate communications and may transmit the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, and/or a memory of the network node described above in connection with FIG. 2. In some aspects, the transmission component 1204 may be co-located with the reception component 1202 in a transceiver.

The communication manager 1208 may transmit or may cause the transmission component 1204 to transmit a first SRS associated with a first duplexing type and a second SRS associated with a second duplexing type that is different from the first duplexing type. The communication manager 1208 may receive or may cause the reception component 1202 to receive an indication to transmit a data channel communication, the indication including an SRI associated with one or more parameters for transmission of the data channel communication. The communication manager 1208 may transmit or may cause the transmission component 1204 to transmit the data channel communication in a slot having the first duplexing type and using a configuration indicated via the SRI and associated with a most-recent SRS associated with the first duplexing type. In some aspects, the communication manager 1208 may perform one or more operations described elsewhere herein as being performed by one or more components of the communication manager 1208.

The communication manager 1208 may receive or may cause the reception component 1202 to receive a first SRS associated with a first duplexing type and a second SRS associated with a second duplexing type that is different from the first duplexing type. The communication manager 1208 may transmit or may cause the transmission component 1204 to transmit an indication to transmit a data channel communication, the indication including an SRI associated with one or more parameters for transmission of the data channel communication. The communication manager 1208 may receive or may cause the reception component 1202 to receive the data channel communication in a slot having the first duplexing type and using a configuration indicated via the SRI and associated with a most-recent SRS associated with the first duplexing type. In some aspects, the communication manager 1208 may perform one or more operations described elsewhere herein as being performed by one or more components of the communication manager 1208.

The communication manager 1208 may include a controller/processor, a memory, a scheduler, and/or a communication unit of the network node described above in connection with FIG. 2. In some aspects, the communication manager 1208 includes a set of components. Alternatively, the set of components may be separate and distinct from the communication manager 1208. In some aspects, one or more components of the set of components may include or may be implemented within a controller/processor, a memory, a scheduler, and/or a communication unit of the network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive a first SRS associated with a first duplexing type and a second SRS associated with a second duplexing type that is different from the first duplexing type. The transmission component 1204 may transmit an indication to transmit a data channel communication, the indication including an SRI associated with one or more parameters for transmission of the data channel communication. The reception component 1202 may receive the data channel communication in a slot having the first duplexing type and using a configuration indicated via the SRI and associated with a most-recent SRS associated with the first duplexing type.

The transmission component 1204 may transmit one or more of a first indication of a first set of SRS resources associated with the first duplexing type and including the first SRS, or a second indication of a second set of SRS resources associated with the second duplexing type and including the second SRS.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: transmitting a first sounding reference signal (SRS) associated with a first duplexing type and a second SRS associated with a second duplexing type that is different from the first duplexing type; receiving an indication to transmit a data channel communication, the indication including an SRS resource index (SRI) associated with one or more parameters for transmission of the data channel communication; and transmitting the data channel communication in a slot having the first duplexing type and using a configuration indicated via the SRI and associated with a most-recent SRS associated with the first duplexing type.

Aspect 2: The method of Aspect 1, wherein the first duplexing type or the second duplexing type comprises subband full duplexing.

Aspect 3: The method of any of Aspects 1-2, wherein the first duplexing type or the second duplexing type comprises non-subband-full-duplexing.

Aspect 4: The method of any of Aspects 1-3, further comprising identifying the slot as having first duplexing type in accordance with one or more of: a slot type of the slot, or a field within the indication to transmit the data channel communication.

Aspect 5: The method of any of Aspects 1-4, further comprising receiving one or more of: a first indication of a first set of SRS resources associated with the first duplexing type and including the first SRS, or a second indication of a second set of SRS resources associated with the second duplexing type and including the second SRS.

Aspect 6: The method of Aspect 5, wherein the first set of SRS resources is associated with one or more of a first quantity of SRS resources or a first quantity of ports, wherein the second set of SRS resources is associated with one or more of a second quantity of SRS resources or a second quantity of ports, and wherein the first quantity of SRS resources is different from the second quantity of SRS resources, or the first quantity of ports is different from the second quantity of ports.

Aspect 7: The method of Aspect 5, further comprising: identifying the SRI associated with the SRS resources of the first SRS resource in association with the first duplexing type and whether the data channel communication is a codebook or a non-codebook communication.

Aspect 8: The method of any of Aspects 1-7, wherein the first SRS and the second SRS are configured for codebook or for non-codebook usage.

Aspect 9: The method of any of Aspects 1-8, wherein the data channel communication is configured for codebook-based physical uplink shared channel (PUSCH) transmission or non-codebook based PUSCH transmission.

Aspect 10: The method of any of Aspects 1-9, wherein the data channel communication is scheduled or activated by one or more of: downlink control information (DCI), a medium access control (MAC) control element (CE), or a radio resource control (RRC) configuration.

Aspect 11: The method of any of Aspects 1-10, wherein the first SRS and the second SRS are within a single SRS resource set, wherein the single SRS resource set includes a first quantity of SRS resources having the first duplexing type and a second quantity of SRS resources having the second duplexing type, and wherein the UE identifies the SRI with the first quantity of SRS resources in association with the slot having the first duplexing type.

Aspect 12: The method of Aspect 11, wherein a size of an SRI bitfield associated with the SRI is associated with a larger of the first quantity or the second quantity.

Aspect 13: The method of Aspect 11, wherein an SRI bitfield is interpreted using least significant bits or most significant bits of the SRI bitfield in association with the SRI being associated with SRS resources having a quantity that is less than unique values of the SRI bitfield.

Aspect 14: The method of any of Aspects 1-13, wherein one or more of the first SRS or the second SRS is configured for non-codebook usage and is associated with a channel state information (CSI)-reference signal (RS) resource, and wherein transmitting the first SRS and the second SRS comprises: transmitting the first SRS in association with a subset of ports associated with a channel state information reference signal (CSI-RS) in association with the first duplexing type comprising subband full duplexing, or transmitting the second SRS in association with a subset of ports associated with a CSI-RS in association with the second duplexing type comprising subband full duplexing.

Aspect 15: The method of Aspect 14, wherein the subset of ports comprises a subset of code division multiplexing (CDM) groups, or wherein the subset of ports comprises a subset of ports within respective CDM groups.

Aspect 16: The method of any of Aspects 1-15, wherein transmitting the first SRS and the second SRS comprises: transmitting the first SRS in association with a first channel state information reference signal (CSI-RS) resource in association with the first duplexing type comprising subband full duplexing, or transmitting the second SRS in association with a second CSI-RS resource in association with the second duplexing type comprising subband full duplexing.

Aspect 17: The method of Aspect 16, wherein the first SRS is included in a first SRS set configured with a non-codebook configuration, wherein the second SRS is included in a second SRS set configured with a non-codebook configuration, and wherein the first SRS is associated with the first CSI resource and the second SRS is associated with the second CSI resource in association with the first SRS set and the second SRS set being configured with a non-codebook configuration.

Aspect 18: The method of any of Aspects 1-17, wherein the first SRS is associated with a first control resource set (CORESET) identifier, and wherein the second SRS is associated with a second CORESET identifier.

Aspect 19: The method of Aspect 18, wherein the first SRS is associated with a first downlink reference signal received in association with the first CORESET identifier, and wherein the second SRS is associated with a second downlink reference signal received in association with the second CORESET identifier.

Aspect 20: The method of any of Aspects 1-19, wherein one or more of the first duplexing type or the second duplexing type comprises subband full duplexing, wherein the subband full duplexing comprises communicating with a first transmission reception point (TRP) associated with the first SRS and communicating with a second TRP associated with the second SRS.

Aspect 21: A method of wireless communication performed by a network node, comprising: receiving a first sounding reference signal (SRS) associated with a first duplexing type and a second SRS associated with a second duplexing type that is different from the first duplexing type; transmitting an indication to transmit a data channel communication, the indication including an SRS resource index (SRI) associated with one or more parameters for transmission of the data channel communication; and receiving the data channel communication in a slot having the first duplexing type and using a configuration indicated via the SRI and associated with a most-recent SRS associated with the first duplexing type.

Aspect 22: The method of Aspect 21, wherein the first duplexing type or the second duplexing type comprises subband full duplexing.

Aspect 23: The method of any of Aspects 21-22, wherein the first duplexing type or the second duplexing type comprises non-subband-full-duplexing.

Aspect 24: The method of any of Aspects 21-23, wherein the slot has a first duplexing type in accordance with one or more of: a slot type of the slot, or a field within the indication to transmit the data channel communication.

Aspect 25: The method of any of Aspects 21-24, further comprising transmitting one or more of: a first indication of a first set of SRS resources associated with the first duplexing type and including the first SRS, or a second indication of a second set of SRS resources associated with the second duplexing type and including the second SRS.

Aspect 26: The method of Aspect 25, wherein the first set of SRS resources is associated with one or more of a first quantity of SRS resources or a first quantity of ports, wherein the second set of SRS resources is associated with one or more of a second quantity of SRS resources or a second quantity of ports, and wherein the first quantity of SRS resources is different from the second quantity of SRS resources, or the first quantity of ports is different from the second quantity of ports.

Aspect 27: The method of Aspect 25, wherein the SRI is associated with the SRS resources of the first SRS resource in association with the first duplexing type and whether the data channel communication is a codebook or a non-codebook communication.

Aspect 28: The method of any of Aspects 21-27, wherein the first SRS and the second SRS are configured for codebook or for non-codebook usage.

Aspect 29: The method of any of Aspects 21-28, wherein the data channel communication is configured for codebook-based physical uplink shared channel (PUSCH) transmission or non-codebook based PUSCH transmission.

Aspect 30: The method of any of Aspects 21-29, wherein the data channel communication is scheduled or activated by one or more of: downlink control information (DCI), a medium access control (MAC) control element (CE), or a radio resource control (RRC) configuration.

Aspect 31: The method of any of Aspects 21-30, wherein the first SRS and the second SRS are within a single SRS resource set, wherein the single SRS resource set includes a first quantity of SRS resources having the first duplexing type and a second quantity of SRS resources having the second duplexing type, and wherein the UE identifies the SRI with the first quantity of SRS resources in association with the slot having the first duplexing type.

Aspect 32: The method of Aspect 31, wherein a size of an SRI bitfield associated with the SRI is associated with a larger of the first quantity or the second quantity.

Aspect 33: The method of Aspect 31, wherein an SRI bitfield is interpreted using least significant bits or most significant bits of the SRI bitfield in association with the SRI being associated with SRS resources having a quantity that is less than unique values of the SRI bitfield.

Aspect 34: The method of any of Aspects 21-33, wherein one or more of the first SRS or the second SRS is configured for non-codebook usage and is associated with a channel state information (CSI)-reference signal (RS) resource, and wherein receiving the first SRS and the second SRS comprises: transmitting the first SRS in association with a subset of ports associated with a channel state information reference signal (CSI-RS) in association with the first duplexing type comprising subband full duplexing, or transmitting the second SRS in association with a subset of ports associated with a CSI-RS in association with the second duplexing type comprising subband full duplexing.

Aspect 35: The method of Aspect 34, wherein the subset of ports comprises a subset of code division multiplexing (CDM) groups, or wherein the subset of ports comprises a subset of ports within respective CDM groups.

Aspect 36: The method of any of Aspects 21-35, wherein receiving the first SRS and the second SRS comprises: receiving the first SRS in association with a first channel state information reference signal (CSI-RS) resource in association with the first duplexing type comprising subband full duplexing, or receiving the second SRS in association with a second CSI-RS resource in association with the second duplexing type comprising subband full duplexing.

Aspect 37: The method of Aspect 36, wherein the first SRS is included in a first SRS set configured with a non-codebook configuration, wherein the second SRS is included in a second SRS set configured with a non-codebook configuration, and wherein the first SRS is associated with the first CSI resource and the second SRS is associated with the second CSI resource in association with the first SRS set and the second SRS set being configured with a non-codebook configuration.

Aspect 38: The method of any of Aspects 21-37, wherein the first SRS is associated with a first control resource set (CORESET) identifier, and wherein the second SRS is associated with a second CORESET identifier.

Aspect 39: The method of Aspect 38, wherein the first SRS is associated with a first downlink reference signal received in association with the first CORESET identifier, and wherein the second SRS is associated with a second downlink reference signal received in association with the second CORESET identifier.

Aspect 40: The method of any of Aspects 21-39, wherein one or more of the first duplexing type or the second duplexing type comprises subband full duplexing, wherein the subband full duplexing comprises communicating via a first transmission reception point (TRP) associated with the first SRS and communicating via a second TRP associated with the second SRS.

Aspect 41: An apparatus for wireless communication at a device, comprising a processor; memory coupled with the processor; and instructions stored in the memory and executable by the processor to cause the apparatus to perform the method of one or more of Aspects 1-40.

Aspect 42: A device for wireless communication, comprising a memory and one or more processors coupled to the memory, the one or more processors configured to perform the method of one or more of Aspects 1-40.

Aspect 43: An apparatus for wireless communication, comprising at least one means for performing the method of one or more of Aspects 1-40.

Aspect 44: A non-transitory computer-readable medium storing code for wireless communication, the code comprising instructions executable by a processor to perform the method of one or more of Aspects 1-40.

Aspect 45: A non-transitory computer-readable medium storing a set of instructions for wireless communication, the set of instructions comprising one or more instructions that, when executed by one or more processors of a device, cause the device to perform the method of one or more of Aspects 1-40.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), identifying, inferring, ascertaining, measuring, and the like. Also, “determining” can include receiving (such as receiving information or receiving an indication), accessing (such as accessing data stored in memory), transmitting (such as transmitting information) and the like. Also, “determining” can include resolving, selecting, obtaining, choosing, establishing and other such similar actions.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, “based on” is intended to be interpreted in the inclusive sense, unless otherwise explicitly indicated. For example, “based on” may be used interchangeably with “based at least in part on,” “associated with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (for example, if used in combination with “either” or “only one of”).

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
transmit a first sounding reference signal (SRS) associated with a first duplexing type and a second SRS associated with a second duplexing type that is different from the first duplexing type;
receive an indication to transmit a data channel communication, the indication including an SRS resource index (SRI) associated with one or more parameters for transmission of the data channel communication; and
transmit the data channel communication in a slot having the first duplexing type and using a configuration indicated via the SRI and associated with a most-recent SRS associated with the first duplexing type.

2. The apparatus of claim 1, wherein the first duplexing type or the second duplexing type comprises subband full duplexing.

3. The apparatus of claim 1, wherein the first duplexing type or the second duplexing type comprises non-subband-full-duplexing.

4. The apparatus of claim 1, wherein at least one processor of the one or more processors is configured to cause the UE to identify the slot as having the first duplexing type in accordance with one or more of:
a slot type of the slot, or
a field within the indication to transmit the data channel communication.

5. The apparatus of claim 1, wherein at least one processor of the one or more processors is configured to cause the UE to receive one or more of:
a first indication of a first set of SRS resources associated with the first duplexing type and including the first SRS, or
a second indication of a second set of SRS resources associated with the second duplexing type and including the second SRS.

6. The apparatus of claim 5, wherein the first set of SRS resources is associated with one or more of a first quantity of SRS resources or a first quantity of ports,
wherein the second set of SRS resources is associated with one or more of a second quantity of SRS resources or a second quantity of ports, and
wherein the first quantity of SRS resources is different from the second quantity of SRS resources, or the first quantity of ports is different from the second quantity of ports.

7. The apparatus of claim 5, wherein at least one processor of the one or more processors is configured to cause the UE to:
identify the SRI associated with the SRS resources of the first SRS resource in association with the first duplexing type and whether the data channel communication is a codebook or a non-codebook communication.

8. The apparatus of claim 1, wherein the first SRS and the second SRS are configured for the same one of codebook usage or non-codebook usage.

9. The apparatus of claim 1, wherein the first SRS and the second SRS are within a single SRS resource set,
wherein the single SRS resource set includes a first quantity of SRS resources having the first duplexing type and a second quantity of SRS resources having the second duplexing type, and
wherein the UE is configured to identify the SRI with the first quantity of SRS resources in association with the slot having the first duplexing type.

10. The apparatus of claim 9, wherein a size of an SRI bitfield associated with the SRI is associated with a larger of the first quantity or the second quantity.

11. The apparatus of claim 1, wherein one or more of the first SRS or the second SRS is configured for non-codebook usage and is associated with a channel state information (CSI)-reference signal (RS) resource, and
wherein, to cause the UE to transmit the first SRS and the second SRS, at least one processor of the one or more processors is configured to cause the UE to:
transmit the first SRS in association with a subset of ports associated with a channel state information reference signal (CSI-RS) in association with the first duplexing type comprising subband full duplexing, or
transmit the second SRS in association with a subset of ports associated with a CSI-RS in association with the second duplexing type comprising subband full duplexing.

12. The apparatus of claim 1, wherein to cause the UE to transmit the first SRS and the second SRS, at least one processor of the one or more processors is configured to cause the UE to:
transmit the first SRS in association with a first channel state information reference signal (CSI-RS) resource in association with the first duplexing type comprising subband full duplexing, or
transmit the second SRS in association with a second CSI-RS resource in association with the second duplexing type comprising subband full duplexing.

13. The apparatus of claim 12, wherein the first SRS is included in a first SRS set configured with a non-codebook configuration,
wherein the second SRS is included in a second SRS set configured with a non-codebook configuration, and
wherein the first SRS is associated with the first CSI resource and the second SRS is associated with the second CSI resource in association with the first SRS set and the second SRS set being configured with a non-codebook configuration.

14. The apparatus of claim 1, wherein the first SRS is associated with a first control resource set (CORESET) identifier, and
wherein the second SRS is associated with a second CORESET identifier.

15. The apparatus of claim 1, wherein one or more of the first duplexing type or the second duplexing type comprises subband full duplexing associated with communicating with a first transmission reception point (TRP) associated with the first SRS and communicating with a second TRP associated with the second SRS.

16. An apparatus for wireless communication at a network node, comprising:
one or more memories storing processor-executable code; and
one or more processors coupled with the one or more memories, at least one processor of the one or more processors configured to cause the network node to:
receive a first sounding reference signal (SRS) associated with a first duplexing type and a second SRS associated with a second duplexing type that is different from the first duplexing type;
transmit an indication to transmit a data channel communication, the indication including an SRS resource index (SRI) associated with one or more parameters for transmission of the data channel communication; and
receive the data channel communication in a slot having the first duplexing type and using a configuration indicated via the SRI and associated with a most-recent SRS associated with the first duplexing type.

17. The apparatus of claim 16, wherein the slot has a first duplexing type in accordance with one or more of:
a slot type of the slot, or
a field within the indication to transmit the data channel communication.

18. The apparatus of claim 16, wherein at least one processor of the one or more processors is configured to cause the network node to transmit one or more of:
a first indication of a first set of SRS resources associated with the first duplexing type and including the first SRS, or
a second indication of a second set of SRS resources associated with the second duplexing type and including the second SRS.

19. The apparatus of claim 18, wherein the first set of SRS resources is associated with one or more of a first quantity of SRS resources or a first quantity of ports,
wherein the second set of SRS resources is associated with one or more of a second quantity of SRS resources or a second quantity of ports, and
wherein the first quantity of SRS resources is different from the second quantity of SRS resources, or the first quantity of ports is different from the second quantity of ports.

20. The apparatus of claim 18, wherein the SRI is associated with the SRS resources of the first SRS resource in association with the first duplexing type and whether the data channel communication is a codebook or a non-codebook communication.

21. A method of wireless communication performed by a user equipment (UE), comprising:
transmitting a first sounding reference signal (SRS) associated with a first duplexing type and a second SRS associated with a second duplexing type that is different from the first duplexing type;
receiving an indication to transmit a data channel communication, the indication including an SRS resource index (SRI) associated with one or more parameters for transmission of the data channel communication; and
transmitting the data channel communication in a slot having the first duplexing type and using a configuration indicated via the SRI and associated with a most-recent SRS associated with the first duplexing type.

22. The method of claim 21, further comprising identifying the slot as having the first duplexing type in accordance with one or more of:
a slot type of the slot, or
a field within the indication to transmit the data channel communication.

23. The method of claim 21, further comprising receiving one or more of:
a first indication of a first set of SRS resources associated with the first duplexing type and including the first SRS, or
a second indication of a second set of SRS resources associated with the second duplexing type and including the second SRS.

24. The method of claim 23, wherein the first set of SRS resources is associated with one or more of a first quantity of SRS resources or a first quantity of ports,
wherein the second set of SRS resources is associated with one or more of a second quantity of SRS resources or a second quantity of ports, and
wherein the first quantity of SRS resources is different from the second quantity of SRS resources, or the first quantity of ports is different from the second quantity of ports.

25. The method of claim 21, wherein the data channel communication is configured for codebook-based physical uplink shared channel (PUSCH) transmission or non-codebook based PUSCH transmission.

26. The method of claim 21, wherein the first SRS is associated with a first control resource set (CORESET) identifier, wherein the second SRS is associated with a second CORESET identifier, wherein the first SRS is associated with a first downlink reference signal received in association with the first CORESET identifier, and wherein the second SRS is associated with a second downlink reference signal received in association with the second CORESET identifier.

27. The method of claim 21, wherein one or more of the first duplexing type or the second duplexing type comprises subband full duplexing,
wherein the subband full duplexing comprises communicating with a first transmission reception point (TRP) associated with the first SRS and communicating with a second TRP associated with the second SRS.

28. A method of wireless communication performed by a network node, comprising:
receiving a first sounding reference signal (SRS) associated with a first duplexing type and a second SRS associated with a second duplexing type that is different from the first duplexing type;
transmitting an indication to transmit a data channel communication, the indication including an SRS resource index (SRI) associated with one or more parameters for transmission of the data channel communication; and
receiving the data channel communication in a slot having the first duplexing type and using a configuration indicated via the SRI and associated with a most-recent SRS associated with the first duplexing type.

29. The method of claim 28, further comprising transmitting one or more of:
a first indication of a first set of SRS resources associated with the first duplexing type and including the first SRS, or
a second indication of a second set of SRS resources associated with the second duplexing type and including the second SRS.

30. The method of claim 29, wherein the first set of SRS resources is associated with one or more of a first quantity of SRS resources or a first quantity of ports,
wherein the second set of SRS resources is associated with one or more of a second quantity of SRS resources or a second quantity of ports, and
wherein the first quantity of SRS resources is different from the second quantity of SRS resources, or the first quantity of ports is different from the second quantity of ports.
